(19) United States
(12) Patent Application Publication
(10) Pub. No.: US 2015/0074454 A1
(43) Pub. Date: Mar. 12, 2015

(54) INFORMATION PROCESSING METHOD AND APPARATUS FOR MIGRATION OF VIRTUAL DISK

(71) Applicant: FUJITSU LIMITED, Kawasaki-shi (JP)

(72) Inventors: Yoshiteru TANAKA, Setagaya (JP); Naoyuki SHIMADA, Kawasaki (JP); Keiko TAKEUCHI, Kawasaki (JP)

(73) Assignee: FUJITSU LIMITED, Kawasaki-shi (JP)

(21) Appl. No.: 14/548,391

(22) Filed: Nov. 20, 2014

Related U.S. Application Data
(63) Continuation of application No. PCT/JP2012/065692, filed on Jun. 20, 2012.

(51) Int. Cl. G06F 11/20

(52) U.S. Cl. CPC G06F 11/203
USPC 714/6.23

(57) ABSTRACT

An information processing method in embodiments of this invention includes: detecting a failure sign of a first physical disk in a system having plural physical disks, each of which stores one or plural virtual disks included in a virtual machine that is executed on a physical machine; identifying one or plural certain virtual disks stored in the first physical disk; and moving at least one of the identified one or plural certain virtual disks to a second physical disk that is a physical disk other than the first physical disk and has a capability to store a virtual disk to be moved to the second physical disk, based on a dynamic or static characteristic of the one or plural certain virtual disks or a dynamic or static characteristic of a physical disk other than the first physical disk.

### CROSS-REFERENCE TO RELATED APPLICATIONS

This application is a continuing application, filed under 35 U.S.C. section 111(a), of International Application PCT/JP2012/065692, filed on Jun. 20, 2012, the entire contents of which are incorporated herein by reference.

### FIELD

This technique relates to migration of a virtual disk included in a virtual machine executed on a physical machine.

### BACKGROUND

Recently, the computer system is virtualized, and a lot of virtual machines are executed on the computer system. In the virtual machine, a guest Operating System (OS) is executed on virtual hardware, and various application programs are further executed on that OS.

The virtual hardware in the virtual machine includes a virtual disk (also called virtual machine storage, a virtual machine disk or a virtual Hard Disk Drive (HDD)), and this virtual disk is stored, for example, as a file in a physical disk (also called a physical HDD) included in the computer system.

There is a case where migration of the virtual disk from a present physical disk to another physical disk is performed due to various reasons. However, there is few investigation about what virtual disk is moved to what physical disk.

Patent Document 1: US Patent application Publication No. 2009/0037680A1

Patent Document 2: Japanese Laid-open Patent Publication No. 2005-326935

Patent Document 3: Japanese Laid-open Patent Publication No. 2010-128963

Conventionally, there is no technique to automatically perform the migration of the virtual disk included in the virtual machine executed on a physical machine included in the system.

### SUMMARY

An information processing method relating to a first aspect of this technique includes: (A) detecting a failure sign of a first physical disk in a system having plural physical disks, each of which stores one or plural virtual disks included in a virtual machine that is executed on a physical machine; (B) identifying one or plural certain virtual disks stored in the first physical disk from association data that associates a virtual disk with a physical disk that stores the virtual disk; and (C) moving at least one of the identified one or plural certain virtual disks to a second physical disk that is a physical disk other than the first physical disk and has a capability to store a virtual disk to be moved to the second physical disk, based on a dynamic or static characteristic of the one or plural certain virtual disks or a dynamic or static characteristic of a physical disk other than the first physical disk.

An information processing method relating to a second aspect of this technique includes: (A) collecting a load indicator value for each physical disk and each virtual disk in a system having plural physical disks, each of which stores one or plural virtual disks included in a virtual machine that is executed on a physical machine; (B) identifying a physical disk for which it is presumed that a period exists in which a load indicator value that is predicted for the physical disk based on the collected load value exceeds a threshold; (C) identifying one or plural certain virtual disks stored in the identified physical disk; (D) identifying a physical disk of a movement destination for at least one of the identified one or plural certain virtual disks from the collected load indicator so that a load indicator value of the identified physical disk after movement and a load indicator value of the physical disk of the movement destination after the movement are less than the threshold in the period; and (E) performing scheduling to move the at least one of the identified one or plural certain virtual disks to the identified physical disk of the movement destination before the period.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting a system configuration example and a hardware configuration example that relate to embodiments of this technique;

FIG. 2 is a diagram depicting a software configuration example of the system;

FIG. 3 is a diagram depicting functional blocks realized by a virtual HDD (Hard Disk Drive) management program in a first embodiment;

FIG. 4 is a diagram depicting an example of a physical HDD priority table;

FIG. 5 is a diagram depicting a processing flow relating to the first embodiment;

FIG. 6 is a diagram depicting an example of a correspondence table;

FIG. 7 is a diagram depicting a processing flow of a failure treatment processing relating to the first embodiment;

FIG. 8 is a diagram depicting a processing flow of a virtual HDD movement processing relating to the first embodiment;

FIG. 9 is a diagram depicting a processing flow of the failure treatment processing relating to the first embodiment;

FIG. 10 is a diagram depicting an example of a priority table for the continuous operation;

FIG. 11 is a diagram depicting a processing flow of the virtual HDD movement processing relating to a second embodiment;

FIG. 12 is a diagram depicting an example of a residual time of the life time of a physical HDD;

FIG. 13 is a diagram depicting an example of a priority table for the continuous operation, which relates to a third embodiment;

FIG. 14 is a diagram depicting a processing flow of a virtual HDD movement processing relating to the third embodiment;

FIG. 15 is a diagram depicting a main processing flow relating to a fourth embodiment;

FIG. 16 is a diagram depicting an example of data stored in a data storage unit in the fourth embodiment;

FIG. 17 is a diagram depicting a processing flow of a virtual HDD movement processing relating to the fourth embodiment;

FIG. 18 is a diagram depicting an example of data for virtual HDDs used in the fourth embodiment;

FIG. 19 is a diagram depicting an example of policy data relating to the fourth embodiment;

FIG. 20 is a diagram depicting an example of point values for virtual HDDs;

FIG. 21 is a diagram depicting a processing flow of the virtual HDD movement processing relating to the fourth embodiment;

FIG. 22 is a diagram depicting an example of data used in the fourth embodiment;

FIG. 23 is a diagram depicting an example of point values for physical HDDs in the fourth embodiment;

FIG. 24 is a schematic diagram depicting a case where the virtual HDD is moved;

FIG. 25 is a diagram depicting changes of load values of the physical HDDs;

FIG. 26 is a diagram depicting an example of point values of the physical HDDs after movement of the virtual HDD;

FIG. 27 is a diagram schematically depicting a case where the virtual HDD is further moved;

FIG. 28 is a diagram depicting an example of a priority table in a fifth embodiment;

FIG. 29 is a diagram depicting an example of an importance degree table in the fifth embodiment;

FIG. 30 is a diagram schematically depicting a data collection example;

FIG. 31 is a diagram depicting a processing flow of a virtual HDD movement processing in the fifth embodiment;

FIG. 32 is a diagram depicting point value calculation of the virtual HDD in the fifth embodiment;

FIG. 33 is a diagram depicting an example of a conversion table for an access frequency;

FIG. 34 is a diagram depicting an example of a conversion table for performance;

FIG. 35 is a diagram depicting point calculation for the access frequency in the fifth embodiment;

FIG. 36 is a diagram depicting point calculation for the performance in the fifth embodiment;

FIG. 37 is a diagram depicting an example of a weight table in the fifth embodiment;

FIG. 38 is a diagram depicting point value calculation for physical HDDs in the fifth embodiment;

FIG. 39 is a diagram depicting a processing flow of a virtual HDD movement processing in the fifth embodiment;

FIG. 40 is a functional block diagram when a virtual HDD management program in a sixth embodiment is executed;

FIG. 41 is a diagram depicting a processing flow in the sixth embodiment;

FIG. 42 is a diagram depicting a processing flow in the sixth embodiment;

FIG. 43 is a diagram to explain load changes with the movement of the virtual HDD;

FIG. 44 is a diagram to explain load changes with the movement of the virtual HDD;

FIG. 45 is a diagram depicting an example of schedule data;

FIG. 46 is a diagram schematically depicting the movement of the virtual HDD; and

FIG. 47 is a functional block diagram of a computer.

### DESCRIPTION OF EMBODIMENTS

### Embodiment 1

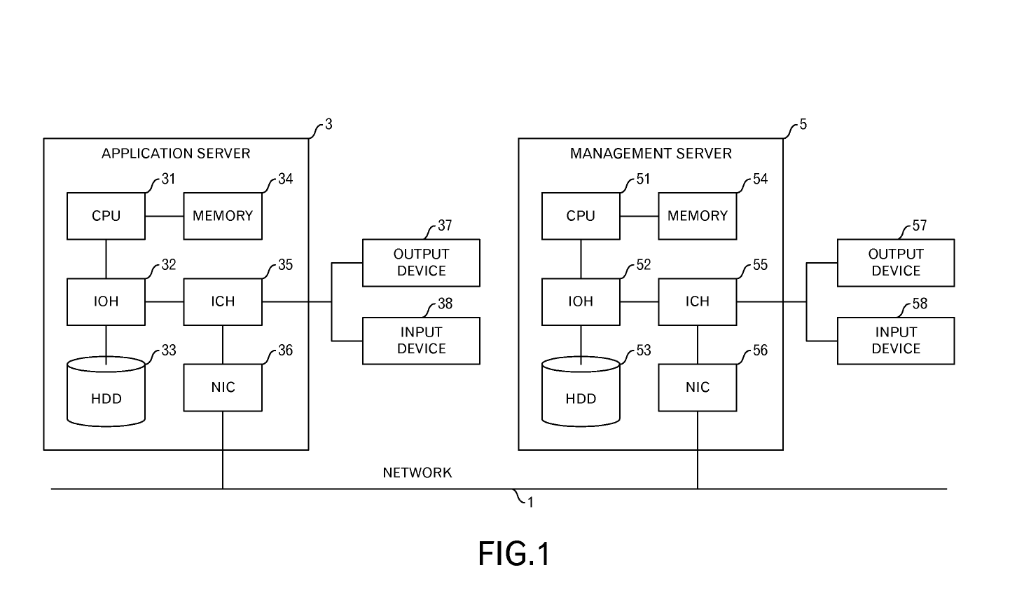

FIG. 1 illustrates a configuration example and a hardware configuration example of a system relating to a first embodiment of this technique. Plural application servers 3 are connected to a network 1. A management server 5 may also be connected to the network 1.

The application server 3 has a Central Processing Unit (CPU) 31, an I/O Hub (IOH) 32, a Hard Disk Drive (HDD) 33, a memory 34, an I/O Controller Hub (ICH) 35 and a Network Interface Card (NIC) 36, and is connected to an input device 38 and an output device 37. The CPU 31 is connected to the memory 34 and the IOH 32, and the IOH 32 is connected to the HDD 33 and ICH 35. The HDD 33 represents one or plural physical HDDs (i.e. physical disks). The ICH 35 is connected to the output device 37 such as a display device and the input device 38 such as a keyboard and a mouse. Moreover, the ICH 35 is also connected to the NIC 36, and the NIC 36 is connected to the network 1. In this embodiment, the virtualization is performed in the application server 3.

The management server 5 has a CPU 51, an IOH 52, a HDD 53, a memory 54, an ICH 55 and a NIC 56, and is connected to an input device 58 and an output device 57. The CPU 51 is connected to the memory 54 and the IOH 52, and the IOH 52 is connected to the HDD 53 and the ICH 55. The ICH 55 is connected to the output device 57 such as the display device, and is connected to the input device 58 such as the keyboard and the mouse. Moreover, the ICH 55 is also connected to the NIC 56, and the NIC 56 is connected to the network 1.

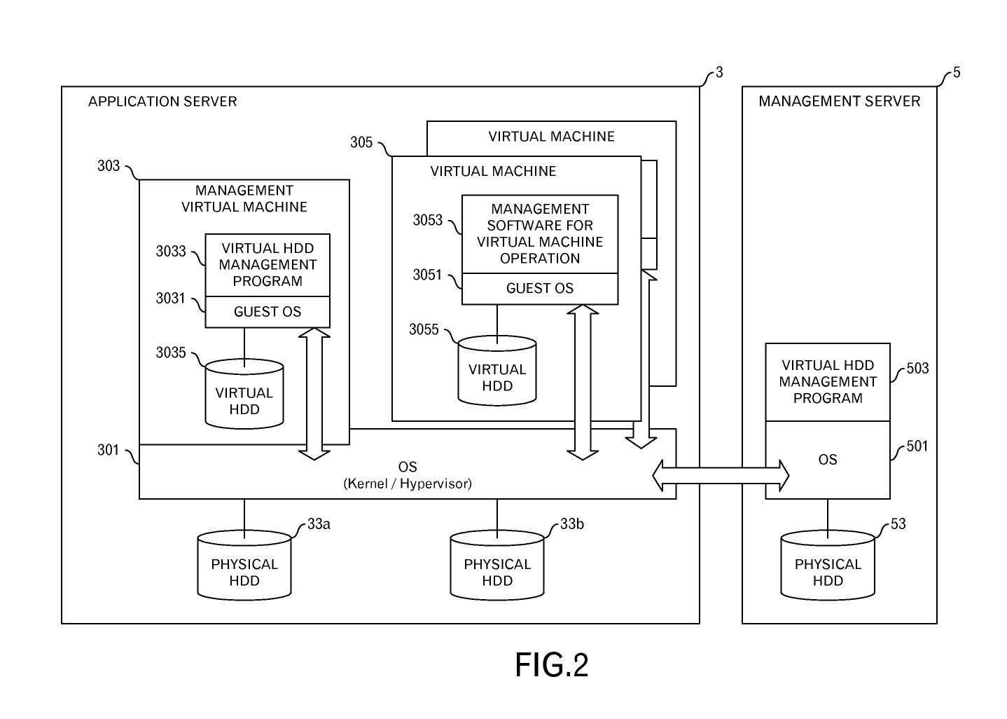

FIG. 2 illustrates a software configuration example of the system illustrated in FIG. 1. The application server 3 is virtualized by a virtualization OS 301 (Kernel/Hypervisor), and plural virtual machines are executed on the application server 3. A virtual machine 305 to perform an application processing has a guest OS 3051, a management software 3053 for the virtual machine operation, a virtual HDD 3055 and the like. Here, only elements relating to this embodiment are illustrated, and the virtual machine 305 includes a virtual CPU, a virtual memory, a virtual NIC, an application program and other elements. The management software 3053 for the virtual machine operation is a program to monitor the status of the virtual HDD 3055. Moreover, a management virtual machine 303 may be executed on the application server 3. The management virtual machine 303 has a guest OS 3031, a virtual HDD management program 3033, a virtual HDD 3035 and the like. Similarly to the virtual machine 305 to perform the application processing, only elements relating to this embodiment are illustrated, and various elements are omitted. The virtual HDD management program 3033 performs a processing to obtain data such as the status of the virtual HDD in the virtual machine while cooperating with the management software 3053 for the virtual machine operation and a processing to perform the migration of the virtual HDD. Furthermore, the virtual HDD management program 3033 obtains data such as the status of the physical HDDs 33a and 33b and the like from the OS 301.

The management server 5 is not virtualized, however, has an OS 501, a physical HDD 53 and a virtual HDD management program 503. The virtual HDD management program 503 is the same as the virtual HDD management program 3033, and one of them is used in the system.

The substance of the virtual HDD is a file that exists in the physical HDD. Therefore, the virtual HDD can move (e.g. be copied) like a normal file, however, because the virtual HDD is tightly coupled with the virtual machine, the virtual HDD is moved, normally, while cooperating with the virtual machine. In this embodiment, the movement of the virtual machine and the virtual HDD (e.g. hot migration) is similar to the conventional technique, therefore, the detailed explanation is omitted.

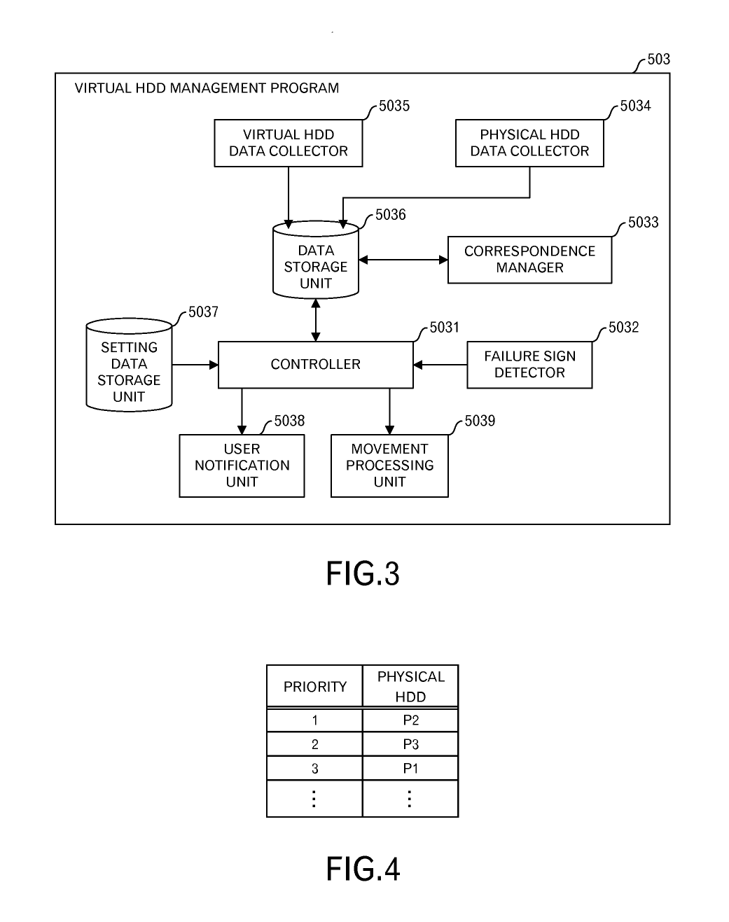

When the virtual HDD management program 503 relating to this embodiment is executed, functions as illustrated in FIG. 3 are realized. In other words, when executing the virtual HDD management program 503, a controller 5031, a failure sign detector 5032, a correspondence manager 5033, a physical HDD data collector 5034, a virtual HDD data collector 5035, a data storage unit 5036, a setting data storage unit 5037, a user notification unit 5038 and a movement processing unit 5039 are realized.

In this embodiment, the failure sign detector 5032 detects the sign of the failure by a detection technique such as Self-Monitoring, Analysis and Reporting Technology (S.M.A.R.T), and notifies the controller 5031 of the detected sign of the failure. The correspondence manager 5033 identifies which physical HDD stores which virtual HDD, and stores correlation data (i.e association data) between the physical HDD and the virtual HDD in the data storage unit 5036.

In this embodiment, the physical HDD data collector 5034 collects data such as data of the vacant capacity of each physical HDD and partition configuration, and stores the collected data in the data storage unit 5036. Moreover, in this embodiment, the virtual HDD data collector 5035 collects data of the capacity of the virtual HDD, and stores the collected data in the data storage unit 5036. The setting data storage unit 5037 stores a physical HDD priority table illustrated in FIG. 4. In an example of FIG. 4, an identifier of a corresponding physical HDD is registered for each priority. In this example, the lesser priority value represents the higher priority. Such data is preset by an administrator or the like.

The user notification unit 5038 sends notification to request to replace the physical HDD or the like in response to an instruction from the controller 5031. Moreover, the movement processing unit 5039 performs a processing to move a specific virtual HDD to a specific movement destination physical HDD in response to an instruction from the controller 5031.

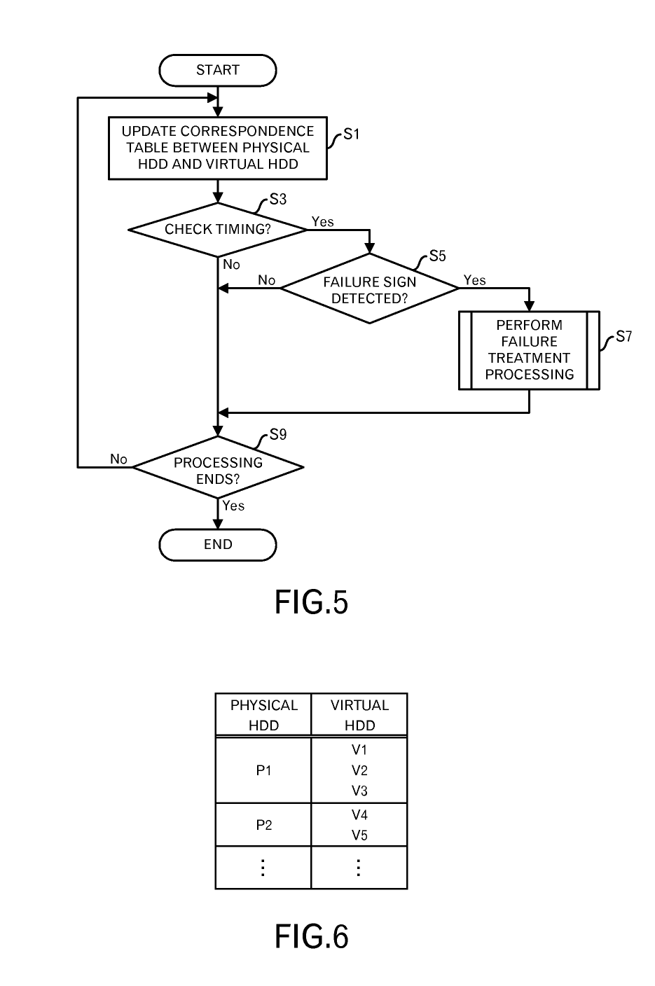

Next, processing flows relating to this embodiment will be explained by using FIGS. 5 to 9.

The correspondence manager 5033 monitors the physical HDDs and virtual HDDs in the system, and updates correlation data (here, a correspondence table) between the physical HDD and the virtual HDD with data of the latest state, for example, periodically (FIG. 5: step S1). The correspondence table is stored in the data storage unit 5036, and is data as illustrated in FIG. 6, for example. In other words, an identifier of a virtual HDD stored in a physical HDD is registered in association with an identifier of the physical HDD.

Then, the failure sign detector 5032 determines whether or not the present time is a check timing of the failure sign (step S3). The failure sign detector 5032 performs the check of the failure sign, for example, periodically. However, the check may not be performed, periodically.

When the present time is the check timing of the failure sign, the failure sign detector 5032 determines whether or not the failure sign is detected, based on various data obtained from the physical HDDs (step S5). As described above, a method other than S.M.A.R.T. may be employed. Then, when no failure sign is detected for any physical HDD, the processing shifts to step S9.

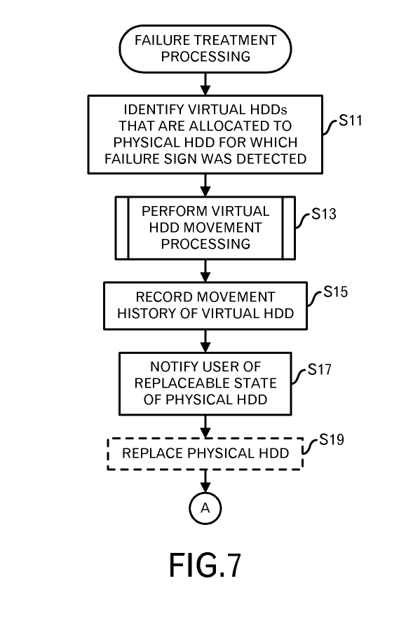

On the other hand, when the failure sign detector 5032 detects the failure sign of any physical HDD 33 in the system, the failure sign detector 5032 notifies the controller 5031 of an identifier of the physical HDD 33. Then, the controller 5031 performs a failure treatment processing (step S7). The failure treatment processing will be explained by using FIGS. 7 to 9. Then, the processing shifts to the step S9.

Such a processing will be repeated until the processing ends such as the virtual HDD management program 503 is ended (step S9).

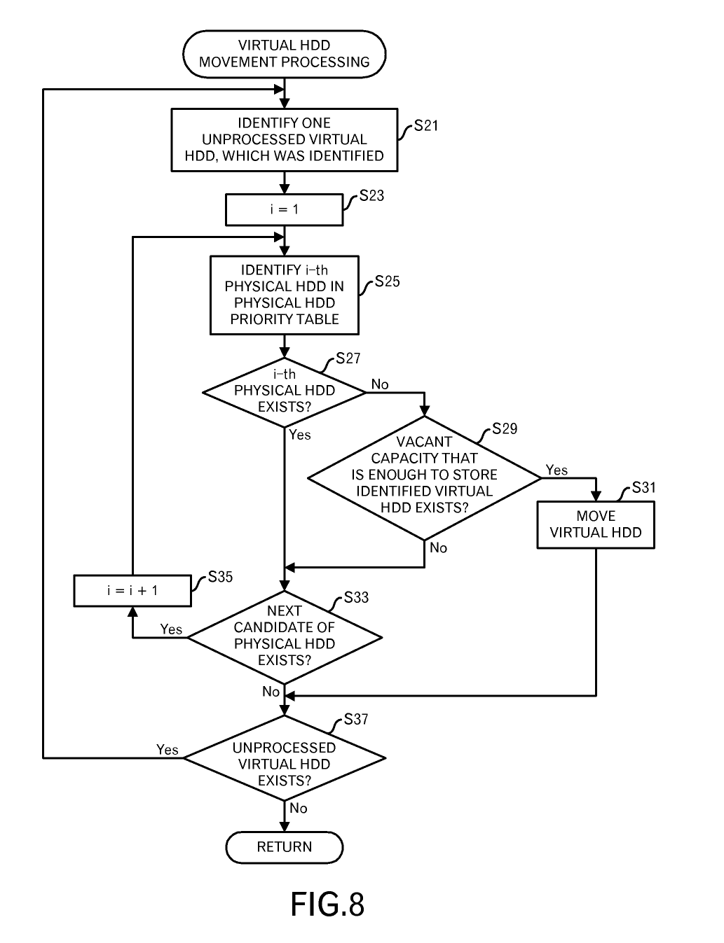

Next, the failure treatment processing will be explained. Firstly, the controller 5031 identifies virtual HDDs that are allocated to the physical HDD, from which the failure sign was detected, from the correlation data stored in the data storage unit 5036 (FIG. 7: step S11). Then, the controller 5031 performs a virtual HDD movement processing (step S13). The virtual HDD movement processing relating to this embodiment will be explained by using FIG. 8.

Here, the virtual HDD movement processing relating to this embodiment will be explained. Firstly, the controller 5031 identifies one unprocessed virtual HDD among the virtual HDDs identified at the step S11 (step S21). Moreover, the controller 5031 initializes a counter i to 1 (step S23). Then, the controller 5031 identifies a physical HDD that has the i-th priority in the physical HDD priority table stored in the setting data storage unit 5037 (step S25).

Furthermore, the controller 5031 determines, based on the correspondence table, whether or not the virtual HDD identified at the step S21 exists in the i-th physical HDD (step S27). When the identified virtual HDD exists in the i-th physical HDD, the virtual HDD cannot be moved to that physical HDD. Therefore, the processing shifts to step S33.

On the other hand, when the identified virtual HDD does not exist in the i-th physical HDD, the controller 5031 determines, based on the vacant capacity of the i-th physical HDD, which is stored in the data storage unit 5036, and the size of the virtual HDD, which is also stored in the data storage unit 5036, whether or not vacant capacity that is enough to store the identified virtual HDD exists (step S29). The controller 5031 itself may obtain the vacant capacity of the i-th physical HDD and data of the size of the virtual HDD at this time. Moreover, the determination at this step is to determine whether or not sufficient vacant capacity remains even when the virtual HDD is moved to the i-th physical HDD.

When there is no vacant capacity that is enough to store the identified virtual HDD in the i-th physical HDD, the processing shifts to the step S33. On the other hand, when there is the vacant capacity that is enough to store the identified virtual HDD in the i-th physical HDD, the controller 5031 instructs the movement processing unit 5039 to move the virtual HDD identified at the step S21 to the i-th physical HDD, and the movement processing unit 5039 performs the movement of the virtual HDD in response to the instruction from the controller 5031 (step S31). Then, the processing shifts to step S37.

Moreover, shifting to the step S33, the controller 5031 determines whether or not a next candidate of the physical HDD exists in the physical HDD priority table (step S33). When there is no next candidate of the physical HDD in the physical HDD priority table, the processing shifts to step S37. On the other hand, when there is a next candidate of the physical HDD in the physical HDD priority table, the controller 5031 increments i by “1” (step S35), and the processing returns to the step S25.

Moreover, shifting to the step S37, the controller 5031 determines whether or not any unprocessed virtual HDD remains among the virtual HDDs identified at the step S11 (step S37). When there is an unprocessed virtual HDD, the processing returns to the step S21. On the other hand, when there is no unprocessed virtual HDD, the processing returns to the calling-source processing.

When such a processing is carried out, the virtual HDD, which is allocated to the physical HDD, for which the failure sign was detected, can be moved according to the physical HDD priority table. When the failure sign is detected, for example, for the physical HDD “P2” in the physical HDD priority table illustrated in FIG. 4, the physical HDDs that have the priority value “2” or lesser are selected as the movement destination physical HDD. According to the capacity limitation, the virtual HDD that cannot be moved may appear.

Returning to the explanation of the processing in FIG. 7, when the movement of the movable virtual HDD is completed, the controller 5031 stores, as a movement history of the virtual HDDs, an identifier of the movement destination physical HDD identified in the processing of FIG. 8 for each virtual HDD identified at the step S11, in the data storage unit 5036 (step S15). Moreover, the controller 5031 instructs the user notification unit 5038 to notify a user such as an administrator that the physical HDD for which the failure sign was detected is in a replaceable state, and the user notification unit 5038 notifies the user such as the administrator according to the instruction (step S17). For example, the notification may be displayed or e-mail or the like may be sent.

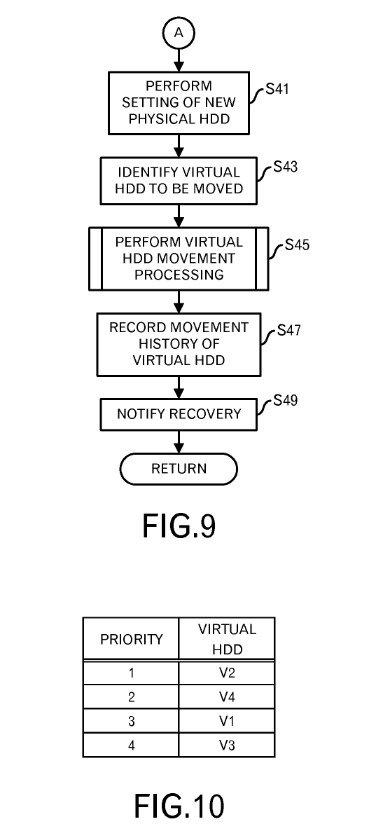

According to this notification, the administrator or the like replaces the physical HDD for which the failure sign was detected (step S19). Because this job is not performed automatically, this step is represented using a dotted block. Because only the replacement is performed, the job is simplified. The processing shifts to a processing in FIG. 9 through terminal A.

Shifting to the processing in FIG. 9, the controller 5031 performs setting of a new physical HDD according to the setting data of the partition configuration and the like, which is stored in the data storage unit 5036 (step S41).

Moreover, the controller 5031 identifies a virtual HDD to be moved, in response to recovery of the physical HDD (step S43). Although there is a case where a virtual HDD other than the virtual HDDs, which were moved, is moved according to the performance of the new physical HDD, the virtual HDDs, which were moved at the step S13, are identified in this embodiment.

Then, the controller 5031 performs a virtual HDD movement processing (step S45). This step may be the same processing as that of the step S13, however, may be different from that of the step S13. In this embodiment, the moved virtual HDD is simply moved to the recovered physical HDD.

When this virtual HDD movement processing is completed, the controller 5031 stores, as the movement history, the identifier of the movement destination physical HDD, which was identified at the step S45, for each virtual HDD identified at the step S43, in the data storage unit 5036 (step S47). Moreover, the controller 5031 instructs the user notification unit 5038 to notify the user such as the administrator of the recovery completion, and the user notification unit 5038 notifies the user according to the instruction (step S49). Then, the processing returns to the calling-source processing.

By carrying out such a processing, it becomes possible to move the virtual HDDs stored in the physical HDD, for which the failure sign was detected according to the physical HDD priority table, and to automatically return the system to the original state in response to the recovery completion of the physical HDD.

### Embodiment 2

In this embodiment, the virtual HDD movement processing is changed to a processing flow as described below. However, as depicted in FIG. 10, a priority table for the continuous operation is stored in the setting data storage unit 5037. In an example of FIG. 10, for each priority, an identifier of a virtual HDD corresponding to the priority is registered. The lesser value of the priority represents the higher priority. Thus, because the virtual HDDs whose continuous operation is prioritized are listed, the virtual HDDs are moved according to this order. The priority table for the continuous priority is registered in advance by the administrator or the like.

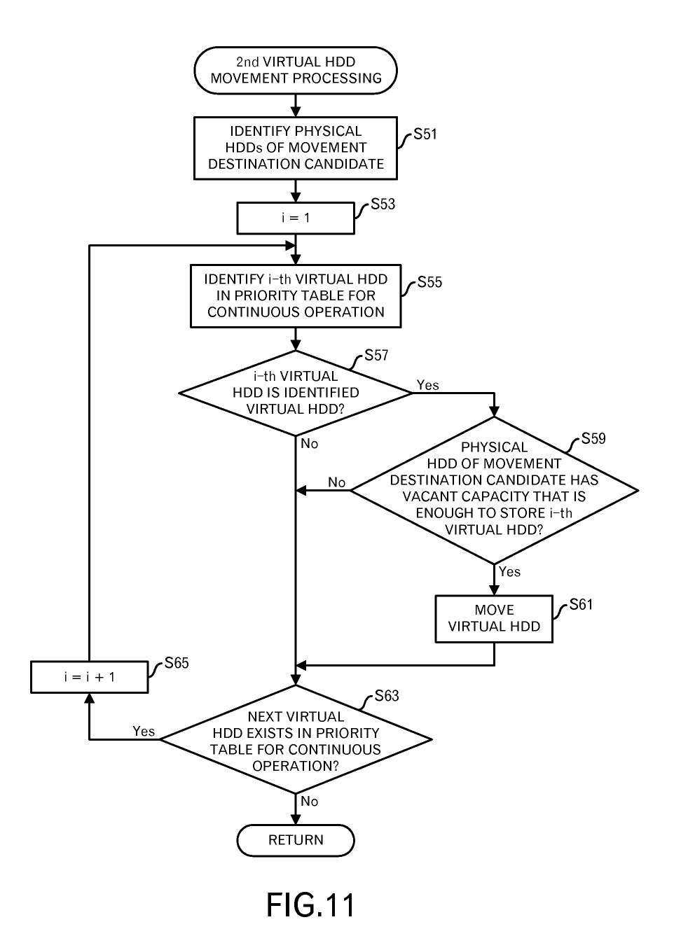

Next, the virtual HDD movement processing using this priority table for the continuous operation will be explained by using FIG. 11. The controller 5031 identifies a physical HDD that becomes a movement destination (i.e. a physical HDD of a movement destination candidate) (step S51). This processing may be a processing to identify physical HDDs that are other than the physical HDD for which the failure sign was detected, among the physical HDDs listed in the physical HDD priority table illustrated in FIG. 4. However, the physical HDDs to be identified may be limited to the top predetermined number of physical HDDs. Moreover, a list in which physical HDDs that are prohibited to be selected as the movement destination physical HDD are listed may be stored in the setting data storage unit 5037, and physical HDDs that are other than the physical HDDs listed in this list and the physical HDD for which the failure sign was detected may be identified as the physical HDD of the movement destination candidate.

Then, the controller 5031 initializes a counter i to “1” (step S53). Moreover, controller 5031 identifies a virtual HDD that has the i-th priority in the priority table for the continuous operation (step S55). Then, the controller 5031 determines whether or not the i-th virtual HDD is any of the virtual HDDs identified at the step S11 (step S57). In other words, the virtual HDDs that are registered in the priority table for the continuous operation are early moved according to that order in order to secure the continuous operation.

When the i-th virtual HDD is not any of the virtual HDDs allocated to the physical HDD for which the failure sign was detected, the processing shifts to step S63. On the other hand, when the i-th virtual HDD is any of the virtual HDDs identified at the step S11, the controller 5031 determines whether or not the vacant capacity that is enough to store the i-th virtual HDD exists in any of the physical HDDs of the movement destination candidate, which are identified at the step S51 (step S59). This step is basically the same as that of the step S29, however, any of the physical HDDs of the movement destination candidate stores the virtual HDD, here. When any of the physical HDDs of the movement destination candidate cannot store the virtual HDD, the processing shifts to the step S63. On the other hand, when any of the identified physical HDDs of the movement destination candidate can store the virtual HDD, the controller 5031 instructs the movement processing unit 5039 to move the i-th virtual HDD to a physical HDD of the movement destination candidate, which is identified firstly, for example, and the movement processing unit 5039 moves the virtual HDD according to the instruction of the controller 5031 (step S61). Then, the processing shifts to the step S63.

The controller 5031 determines whether or not there is a virtual HDD that has a next priority in the priority table for the continuous operation (step S63). When there is a virtual HDD that has a next priority, the controller 5031 increments the counter i by “1” (step S65), and the processing returns to the step S55. On the other hand, when there is no virtual HDD that has the next priority, the processing returns to the calling-source processing.

When there is a virtual HDD that is not listed in the priority table for the continuous operation, however, was identified at the step S11, it may be determined whether or not that virtual HDD can be moved to any of the physical HDDs of the movement destination candidate, before returning to the calling-source processing, and if the virtual HDD can be moved, the virtual HDD may be moved.

Accordingly, it is possible to move the virtual HDD from the virtual HDD whose continuous operation is prioritized, in sequence, and it becomes possible to continue the operation as much as possible.

Moreover, by automatically moving the virtual HDD, it is possible to lower the maintenance cost.

### Embodiment 3

In this embodiment, modification of the virtual HDD movement processing at the step S45, which is executed after replacing the physical HDD will be explained.

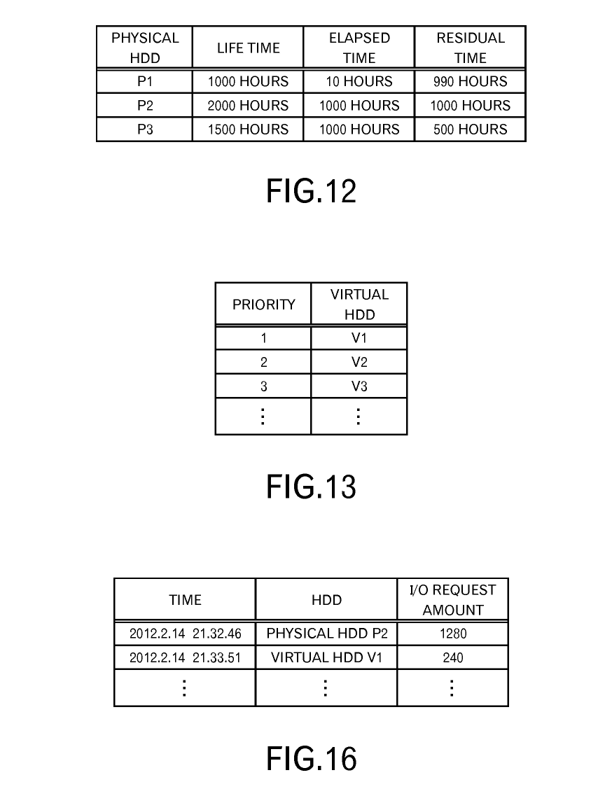

In this embodiment, the physical HDD data collector 5034 collects data for an operating time of each physical HDD in the system, and stores the collected data in the data storage unit 5036. For example, data as illustrated in FIG. 12 is managed in the data storage unit 5036. In an example of FIG. 12, for each physical HDD, a life time set by an administrator or the like, an elapsed time collected by the physical HDD data collector 5034 and a residual time that is a difference between the life time and the elapsed time are registered. The life time may be calculated from Mean Time Between Failure (MTBF), for example.

Moreover, also in this embodiment, a priority table for the continuous operation as illustrated in FIG. 13 is stored in the setting data storage unit 5037. In an example of FIG. 13, for each priority, an identifier of the virtual HDD is registered.

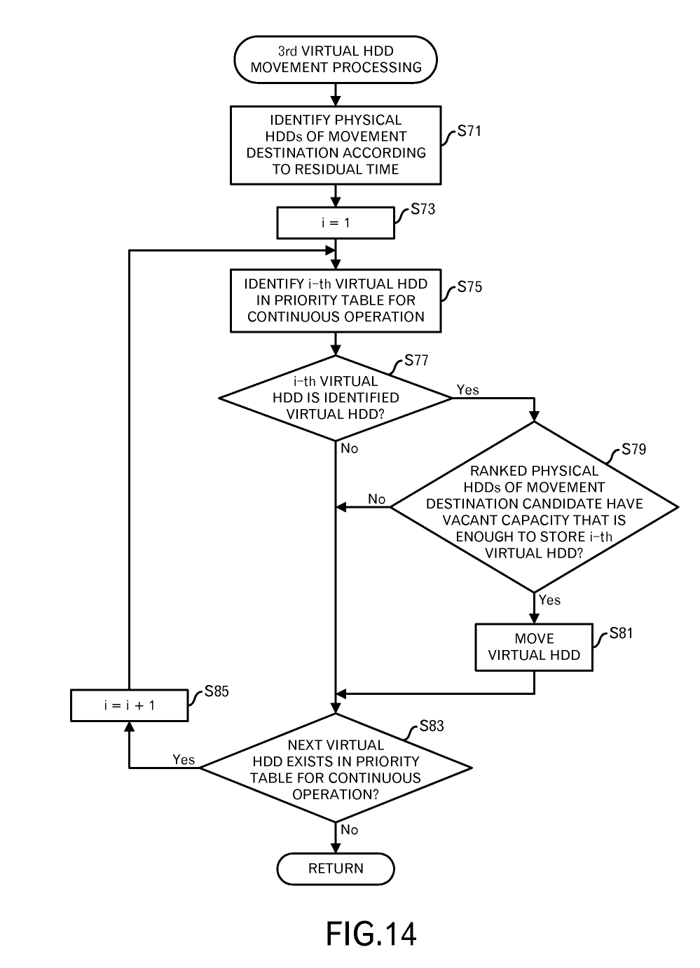

Then, in this embodiment, the virtual HDD movement processing as illustrated in FIG. 14 is performed at the step S45. At the step S43 in FIG. 9 as the presumption, the virtual HDDs, which were stored in the physical HDD, for which the failure sign was detected, are identified as the virtual HDDs to be moved.

The controller 5031 identifies physical HDDs of the movement destination candidate according to the residual time stored in the data storage unit 5036 (step S71). For example, the physical HDDs are sorted in descending order of the residual time to determine, in this order, whether or not the virtual HDD can move to the physical HDD of the movement destination candidate. Even in case where the elapsed time is short, when the life time is short, the residual time is short. For example, the physical HDD “P1” is a physical HDD, which has just been installed, however, the life time is short. Therefore, the residual time is relatively shorter than that of the physical HDD “P2”. Therefore, in an example of FIG. 12, the physical HDD is checked in order of “P2”, “P1” and “P3”,

Moreover, the controller 5031 initializes a counter i to “1” (step S73). Then, the controller 5031 identifies a virtual HDD that has the i-th priority in the priority table for the continuous operation (step S75). Then, the controller 5031 determines whether or not the i-th virtual HDD is any of the virtual HDDs, which were identified at the step S43 (step S77). In other words, the virtual HDDs that are registered in the priority table for the continuous operation are moved early in that order. Therefore, it is possible to secure the continuous operation.

When the i-th virtual HDD is not the virtual HDD identified at the step S43, the processing shifts to step S83. On the other hand, when the i-th virtual HDD is any of the virtual HDDs identified at the step S43, the controller 5031 determines, in order identified at the step S71, whether or not the vacant capacity that is enough to store the i-th virtual HDD exists in any of the physical HDDs of the movement destination candidate (step S79).

In case of the aforementioned order, it is determined whether or not the virtual HDD “V1” that has the highest priority in the priority table for the continuous operation (FIG. 13) can be stored in the physical HDD “P2”, and if impossible, it is determined whether or not the virtual HDD “V1” can be stored in the physical HDD “P1”, and furthermore, if impossible, it is determined whether or not the virtual HDD “V1” can be stored in the physical HDD “P3”.

When the virtual HDD cannot be stored in any of the physical HDDs of the movement destination candidate, the processing shifts to the step S83. On the other hand, when the virtual HDD can be stored in any of the identified physical HDDs of the movement destination candidate, the controller 5031 instructs the movement processing unit 5039 to move the i-th virtual HDD to the physical HDD of the movement destination, which was the firstly identified physical HDD of the movement destination candidate, for example, and the movement processing unit 5039 moves the virtual HDD according to the instruction of the controller 5031 (step S81). Then, the processing shifts to the step S83.

Moreover, the controller 5031 determines whether or not the virtual HDD that has the next priority exists in the priority table for the continuous operation (step S83). When the virtual HDD that has the next priority exists, the controller 5031 increments the counter i by “1” (step S85), and the processing returns to the step S75. On the other hand, when there is not virtual HDD that has the next priority, the processing returns to the calling-source processing.

Accordingly, it is possible to move the virtual HDD to the physical HDD that has the long residual time, instead of the recovered physical HDD, because the continuous operation is prioritized.

The processing in FIG. 14 may be performed by identifying all virtual HDDs at the step S43. Then, the virtual HDD is rearranged regardless of the movement at the step S45 in order of the priority table for the continuous operation.

### Embodiment 4

In this embodiment, an example will be explained that the priority of the virtual HDD and the movement destination physical HDD are determined based on load data, which varies dynamically.

Therefore, in this embodiment, the virtual HDD data collector 5035 obtains data of an I/O request amount (access frequency per unit time) to each virtual HDD from the management software 3053 for the virtual machine operation, and stores the obtained data in the data storage unit 5036. Moreover, the physical HDD data collector 5034 obtains data of an I/O request amount (access frequency per unit time) to each physical HDD from the Os on each physical machine included in the system, for example, and stores the obtained data in the data storage unit 5036.

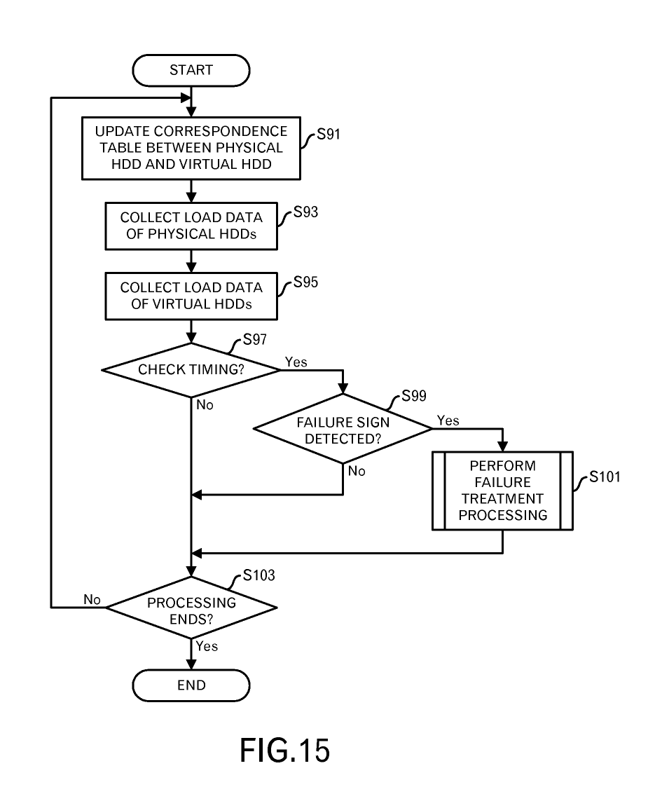

Moreover, in this embodiment, a processing in FIGS. 15 to 27 is performed.

Firstly, the correspondence manager 5033 monitors the physical HDDs and virtual HDDs in the system, and updates the state of the collation data (i.e. the association data) between the physical HDD and the virtual HDD (here, a correspondence table), periodically, for example, with the latest state (FIG. 15: step S91). The correspondence table is stored in the data storage unit 5036, and is data illustrated in FIG. 6, for example.

Furthermore, the physical HDD data collector 5034 collects the load data (data of the I/O request amount) from the OS or the like in each physical machine in the system, for example, and stores the collected load data in the data storage unit 5036 (step S93). Moreover, the virtual HDD data collector 5035 obtains the load data (data of the I/O request amount) from the management software 3053 for the virtual machine operation, and stores the obtained data in the data storage unit 5036 (step S95).

For example, data as illustrated in FIG. 16 is stored in the data storage unit 5036. In an example of FIG. 16, a time, an identifier of the HDD and an I/O request amount are correlated and stored.

Then, the failure sign detector 5032 determines whether or not the present time is the check timing of the failure sign (step S97). The failure sign detector 5032 checks the failure sign, periodically, for example. However, the check may not be performed, periodically.

When the present time is the check timing of the failure sign, the failure sign detector 5032 determines whether or not the failure sign is detected, based on various data obtained from the physical HDD (step S99). As described above, any method other than S.M.A.R.T. may be employed. Then, when no failure sign is detected in any physical HDDs, the processing shifts to step S103.

On the other hand, when the failure sign detector 5032 detects the failure sign of any physical HDD in the system, the failure sign detector 5032 notifies the controller 5031 of an identifier of the detected physical HDD. Then, the controller 5031 performs a failure treatment processing (step S101). The failure treatment processing is the same as those in FIGS. 7 and 9. Then, the processing shifts to step S103.

This processing is repeated until the processing ends such as the virtual HDD management program 503 is ended (step S103).

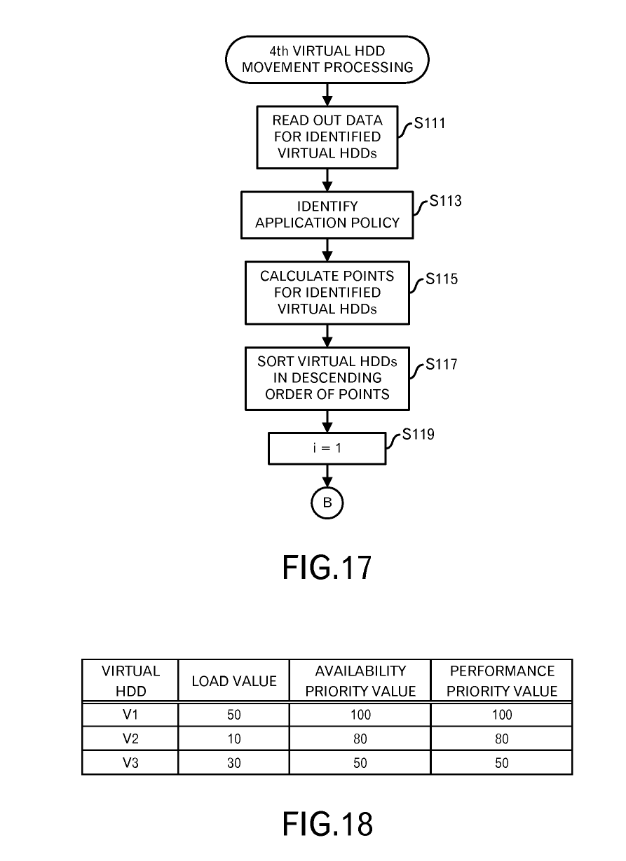

The failure treatment processing is the same as that in the first embodiment, however, the virtual HDD movement processing in the failure treatment processing is changed to a processing of FIGS. 17 and 21.

Firstly, the controller 5031 reads out data for the virtual HDD identifies at the step S11 from the data storage unit 5036 and the setting data storage unit 5037 (step S111). In this embodiment, the preset availability priority value and performance priority value are stored in the setting data storage unit 5037 for each virtual HDD, and such data is read out. Moreover, in this embodiment, as illustrated in FIG. 16, the data of the I/O request amount is stored for each virtual HDD in the data storage unit 5036. Therefore, an average value or the like in a predetermined period is calculated as the load value, or a latest value is read out as the load value. For example, data as illustrated in FIG. 18 is read out. In an example of FIG. 18, for each identified virtual HDD, a load value, an availability priority value and a performance priority value are correlated. As for the load value, availability priority value and performance priority value, a higher value represents a higher priority for the movement.

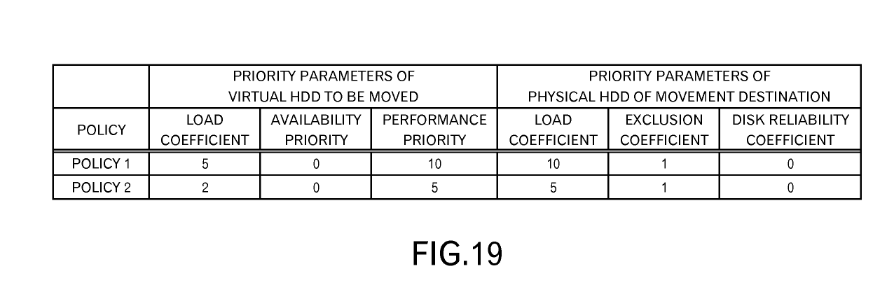

Moreover, the controller 5031 reads out data of an application policy stored in the setting data storage unit 5037 (step S113). For example, data as illustrated in FIG. 19 is stored in the setting data storage unit 5037. In an example of FIG. 19, two policies are prepared, and any policy, which is set by an administrator, for example, is read out as a present application policy. The policy includes a priority parameter of the virtual HDD to be moved, and a priority parameter of the movement destination physical HDD to be moved. The priority parameter of the virtual HDD to be moved includes a load coefficient of the virtual HDD, an availability priority and a performance priority of the virtual machine, and represents a weight for each of the load of the virtual HDD, availability and performance. Moreover, the priority parameter of the movement destination physical HDD includes a load coefficient of the physical HDD, an exclusion coefficient and a disk reliability coefficient, and represents weights for a load of the physical HDD, an exclusiveness degree and reliability. For example, policy 1 is designated among these, and data of this policy 1 is read out.

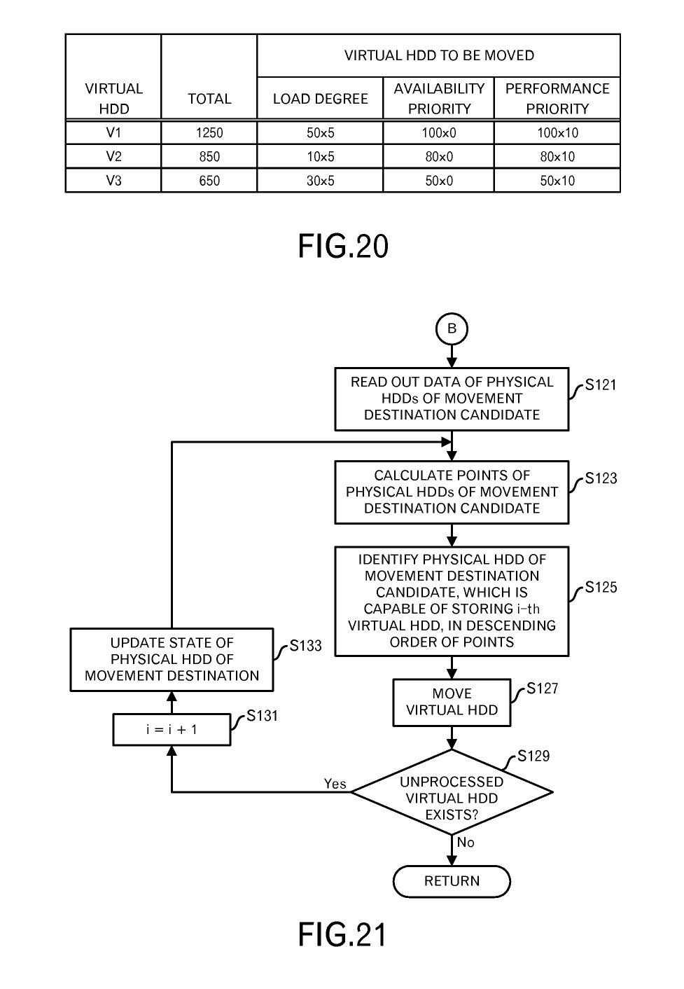

Then, the controller 5031 calculates points for the virtual HDDs identified at the step S11 from data read out at the step S111 and data of the application policy (step S115). In this embodiment, a total point value is calculated by (the load value of the virtual HDD*the load coefficient of the virtual HDD+the availability priority value*the availability priority+the performance priority value*the performance priority of the virtual machine). For example, in case of the example of FIGS. 18 and 19, a point value for each virtual HDD is calculated as illustrated in FIG. 20. In an example of FIG. 20, the details (the load degree, availability priority and performance priority) are also depicted. However, the total point value is obtained for each virtual HDD.

Moreover, the controller 5031 sorts the virtual HDDs in descending order of the point (step S117). The virtual HDD that has a higher point is moved with the priority. Then, the controller 5031 initializes a counter i to “1” (step S119). The processing shifts to a processing in FIG. 21 through terminal B.

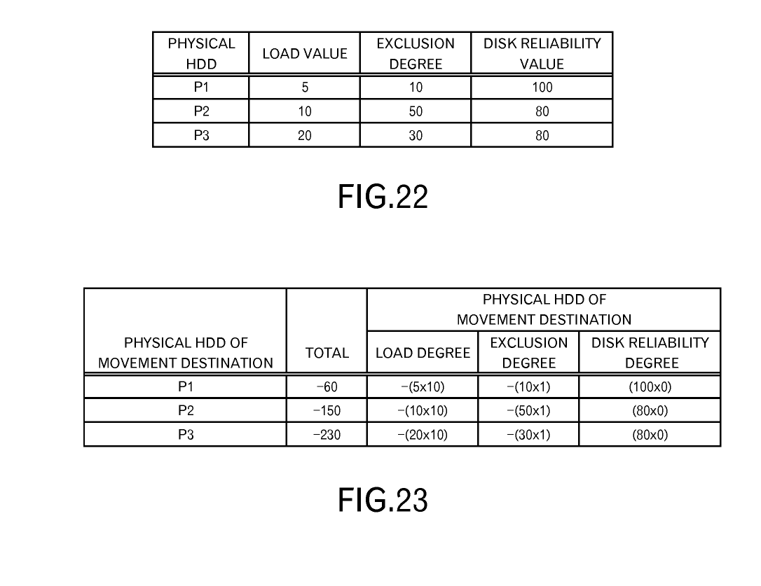

Shifting to the explanation of the processing of FIG. 21, the controller 5031 reads out data of the physical HDD of the movement destination candidate from the setting data storage unit 5037 and the data storage unit 5036 (step S121). In this embodiment, the exclusiveness degree and the disk reliability value for each physical HDD are stored in the setting data storage unit 5037, for example, and this data is read out for the physical HDDs (i.e. physical HDDs of the movement destination candidate) other than the physical HDD for which the failure sign was detected, for example. Moreover, for the physical HDDs of the movement destination candidate, the load values are read out from the data storage unit 5036. For example, it is assumed that data as illustrated in FIG. 22 is read out. In an example of FIG. 22, for each physical HDD, a load value, an exclusion degree and a disk reliability degree are correlated. Here, the greater load value is undesirable as the physical HDD of the movement destination, and the greater exclusion degree is undesirable as the physical HDD of the movement destination. On the other hand, the greater disk reliability is desirable as the physical HDD of the movement destination.

Then, the controller 5031 calculates points for the physical HDDs of the movement destination candidate from the application policy and the read data of the physical HDDs (step S123). When the policy 1 is the application policy and data as illustrated in FIG. 22 is read out, point values as illustrated in FIG. 23 are calculated. Here, because the greater load value and greater exclusion degree are undesirable, a negative value is assigned to the load value and the exclusion degree, and a positive value is assigned to the disk reliability degree. In other words, a point is calculated by −((load value)*(load coefficient))−((exclusion degree)*(exclusion coefficient))+((disk reliability value)*(disk reliability coefficient)).

After that, the controller 5031 identifies, for the i-th virtual HDD, the physical HDD of the movement destination candidate, which can store the i-th virtual HDD, in descending order of the point, as the physical HDD of the movement destination (step S125). In an example of FIG. 23, it is determined in order of “P1”, “P2” and “P3” whether or not the physical HDD of the movement destination candidate can store the i-th virtual HDD, and a physical HDD of the movement destination candidate, which is firstly identified as being able to store, is identified.

Then, the controller 5031 instructs the movement processing unit 5039 to move the i-th virtual HDD to the identified physical HDD of the movement destination, and the movement processing unit 5039 performs the movement of the virtual HDD according to the instruction from the controller 5031 (step S127). In the aforementioned example, it is assumed that the virtual HDD “V1” is moved to the physical HDD “P1”.

Moreover, the controller 5031 determines whether or not there is unprocessed virtual HDD among the identified virtual HDDs (step S129). When there is an unprocessed virtual HDD, the controller 5031 increments the counter i by “1” (step S131), and updates the state of the physical HDD of the movement destination, which is identified at the step S125 (step S133). When the virtual HDD “V1” is moved to the physical HDD “P1”, the load value “50” of the virtual HDD “V1” is added to the load value “5” of the physical HDD, and the new load value “55” is obtained. Then, the processing returns to the step S123.

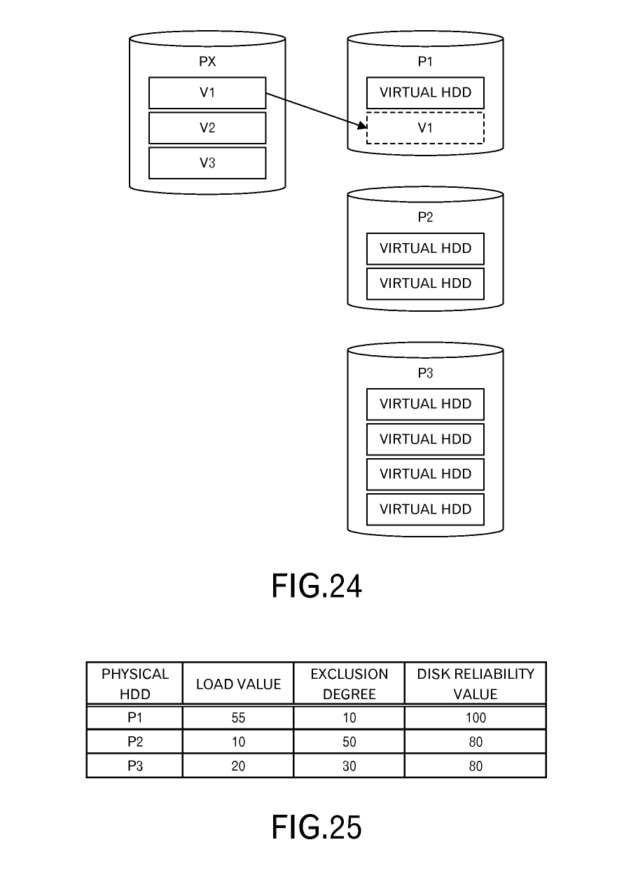

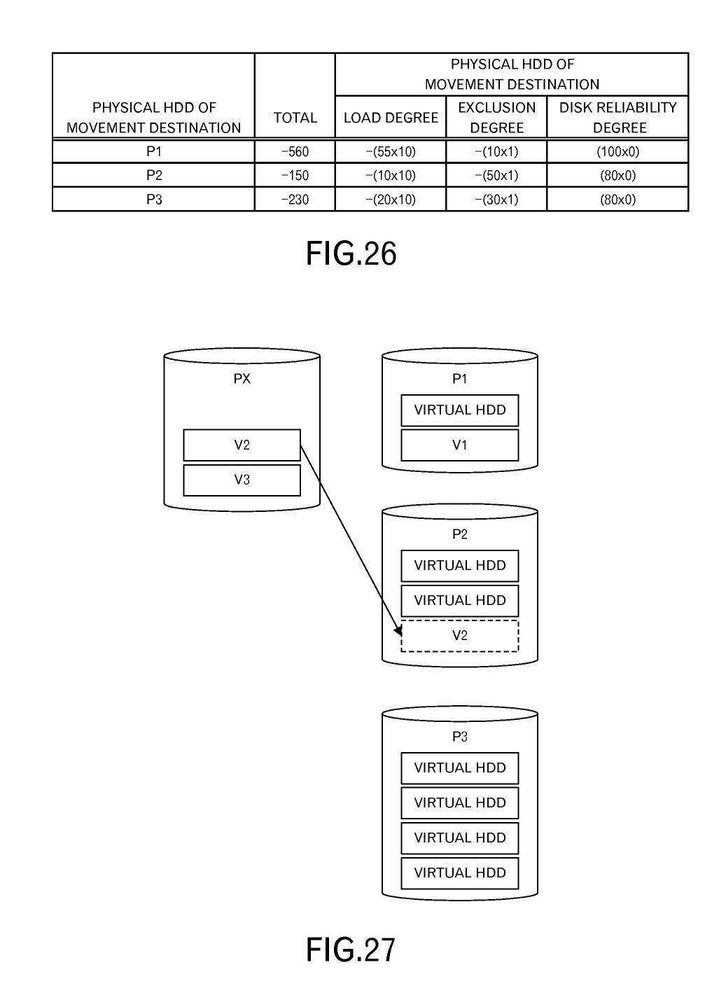

As described above, as schematically illustrated in FIG. 24, when the virtual HDD “V1” is moved to the physical HDD “P1”, the load of the physical HDD “P1” is heightened as illustrated in FIG. 25. The point is recalculated for at least the physical HDD of the movement destination at the step S123 according to such a state change. Then, data in FIG. 23 is changed to data as illustrated in FIG. 26. According to the example of FIG. 26, the physical HDD that has the greatest total point value is changed to “P2”. Therefore, as illustrated in FIG. 27, the virtual HDD “V2” is moved to the physical HDD “P2”.

By performing the aforementioned processing, it is possible to determine the movement order of the virtual HDD and the physical HDD of the movement destination in form that the present load states of the physical HDDs and virtual HDDs are taken into consideration.

Also in this embodiment, the step S45 in the failure treatment processing is performed, however, when the load data (i.e. data of the access frequency) is collected as described above, whether or not the movement of the virtual HDD can be made may be determined based on the load data of the virtual HDD and the performance data of the physical HDD, which is newly equipped. In other words, when the performance of the physical HDD, which is newly equipped, does not reach a predetermined level, there is a possibility that the throughput is lowered in case where the load of the virtual HDD is high. Therefore, it may be determined that the virtual HDD is not returned to the physical HDD, which is newly equipped.

Moreover, the migration is performed according to the policy defined by the administrator or the like.

### Embodiment 5

In this embodiment, a performance indicator value of the physical HDD, which varies dynamically, is further taken into consideration to determine the physical HDD of the movement destination.

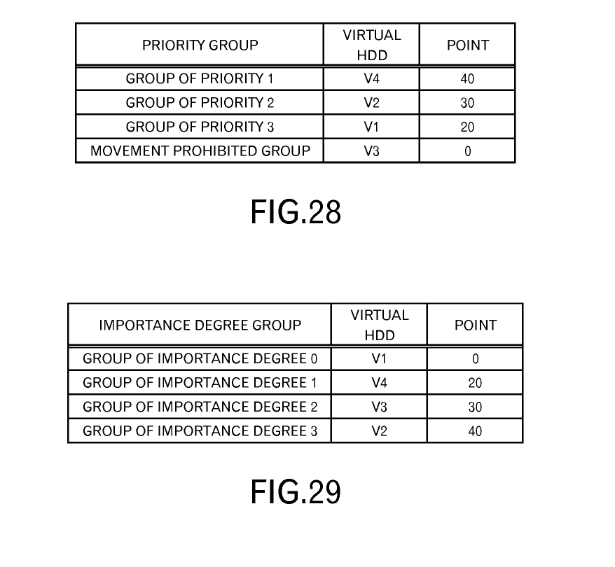

In this embodiment, data of the priority and importance degree (e.g. degree representing an inclusive degree of importance data) is stored in advance for each virtual HDD in the setting data storage unit 5037. For example, as for the priority, data as illustrated in FIG. 28 is stored. In an example of FIG. 28, for each priority group, identifiers of virtual HDDs, which belong to that group, and a point value assigned to that group are correlated. It is assumed that the priority groups include a group that the movement is prohibited, and the lesser point value of the priority represents a higher priority.

Moreover, as for the importance degree, data as illustrated in FIG. 29 is stored. In an example of FIG. 29, for each importance degree group, identifiers of virtual HDDs, which belong to that group, and a point value assigned to that group are correlated. It is assumed that the greater point value of the importance degree represents a higher importance degree.

Moreover, in this embodiment, the access frequency (e.g. the I/O request amount per unit time) and the performance indicator value (e.g. a period required to notify the completion in case where one block (e.g. 64 KB) is written) for the physical HDD are obtained periodically, for example. For example, an administrator or the like designates a keeping period of data (i.e. a range for which the moving average is calculated). For example, a case that only moment data is used, a case that the moving average is calculated by using the data keeping period such as one week or the like or a case that the moving average is calculated by using the data keeping period such as one month is designated. Furthermore, an interval to obtain data, i.e. a polling interval is designated by the administrator or the like, and such data is set in the physical HDD data collector 5034, and the physical HDD data collector 5034 performs data collection according to this designation.

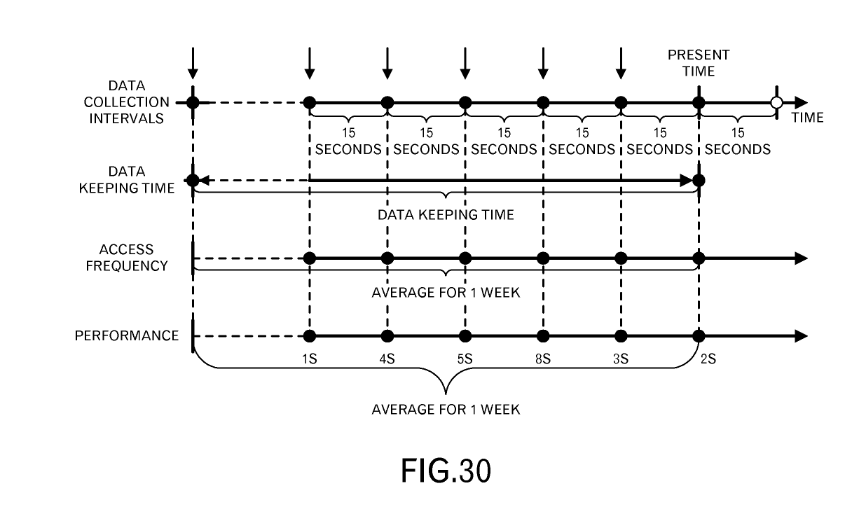

For example, when the data keeping period is one week and the polling interval is 15 seconds, as illustrated in FIG. 30, the access frequency (the number of times) and performance (time [second]) are collected at intervals of 15 seconds and collected data is kept one week. Therefore, an average value for one week is calculated. The average value is also calculated by the physical HDD data collector 5034. However, the average value may be calculated at the point calculation.

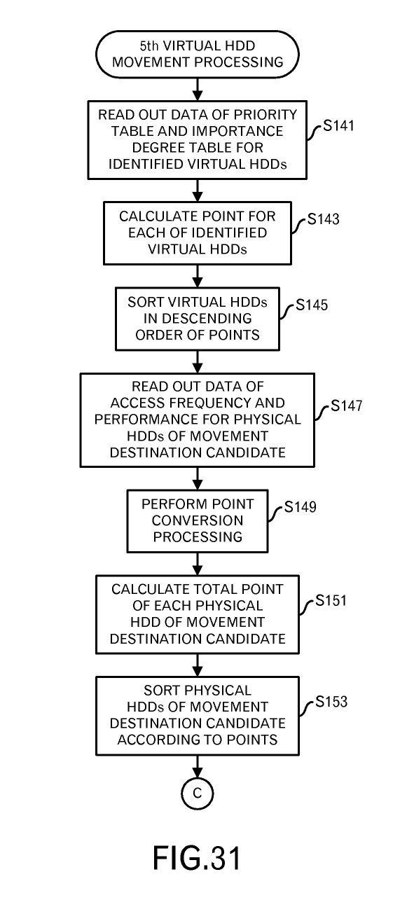

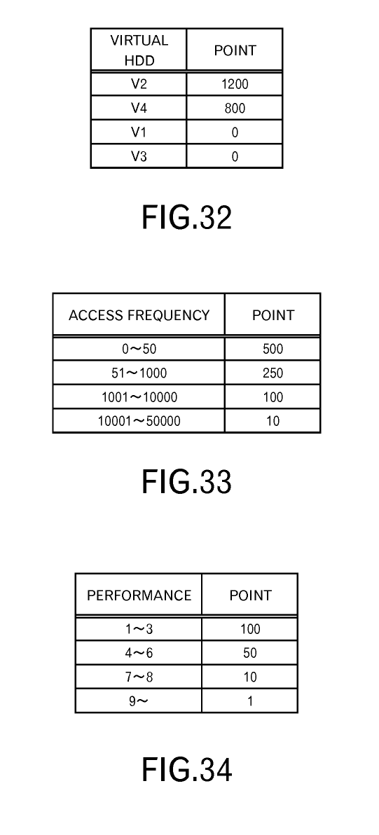

Next, a processing flow of the virtual HDD movement processing relating to this embodiment will be explained by using FIGS. 31 to 39. The controller 5031 reads out data of the priority table (FIG. 28) and the importance degree table (FIG. 29) for each virtual HDD identified at the step S11 (FIG. 31: step S141). Then, the controller 5031 calculates a point value for each identified virtual HDD (step S143). In this embodiment, a point value is calculated by the priority*the importance degree. For example, in an example of the virtual HDDs “V1” to “V4”, point values as illustrated in FIG. 32 are calculated. In case of the point value “0”, the movement is not performed.

Then, the controller 5031 sorts the virtual HDDs in descending order of the point values (step S145). In an example of FIG. 32, the order “V2 then V4” is assigned.

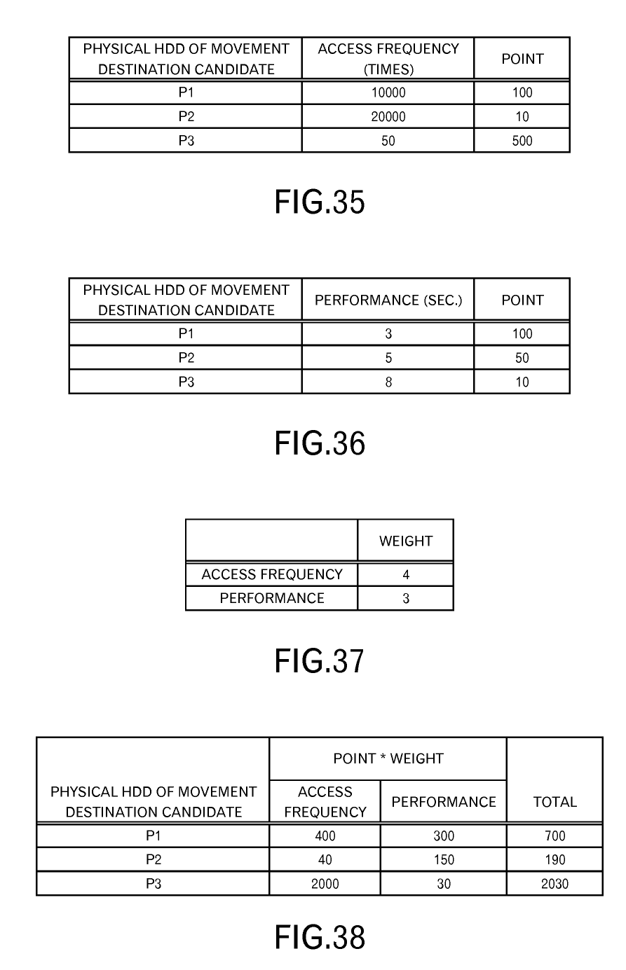

Moreover, the controller 5031 reads out data for the access frequency and performance from the data storage unit 5036 for each of the physical HDDs of the movement destination candidate (step S147). Then, the controller 5031 performs a point conversion processing to calculate an access frequency point and performance point for each physical HDD of the movement destination candidate, based on the read data according to a conversion table (step S149). The conversion table for the access frequency correlates a range of the access frequency and a point value, for example, as illustrated in FIG. 33. Moreover, the conversion table for the performance correlates a range of the performance and a point value, for example, as illustrated in FIG. 34. From these conversion tables, a point value corresponding to the access frequency or performance is read out. For example, it is assumed that a point value for the access frequency of each physical HDD of the movement destination candidate as illustrated in FIG. 35 is obtained. Moreover, it is assumed that a point value for the performance of each physical HDD of the movement destination candidate as illustrated in FIG. 36 is obtained. As for each of them, a greater value of the access frequency or performance corresponds to a lesser point value.

Furthermore, the controller 5031 calculates a total point value for each physical HDD of the movement destination candidate according to a weight table stored in the setting data storage unit 5037 (step S151). The weight table is a table set in advance by the administrator or the like, and is data as illustrated in FIG. 37, for example. In other words, this table represents a ratio of the access frequency and the performance to be weighted. Then, in this embodiment, a total point value is calculated by (a point value of the access frequency*a weight of the access frequency+a point value of the performance*a weight of the performance). In examples of FIGS. 35 to 37, the total point value is calculated as illustrated in FIG. 38. In an example of FIG. 38, weighted point values for the access frequency and the performance are depicted, and as for the access frequency, the physical HDD “P3” has the greatest point value, and as for the performance, the physical HDD “P1” has the greatest point value. However, because the weight of the access frequency is greater, the total point value of the physical HDD “P3” is greatest as the result.

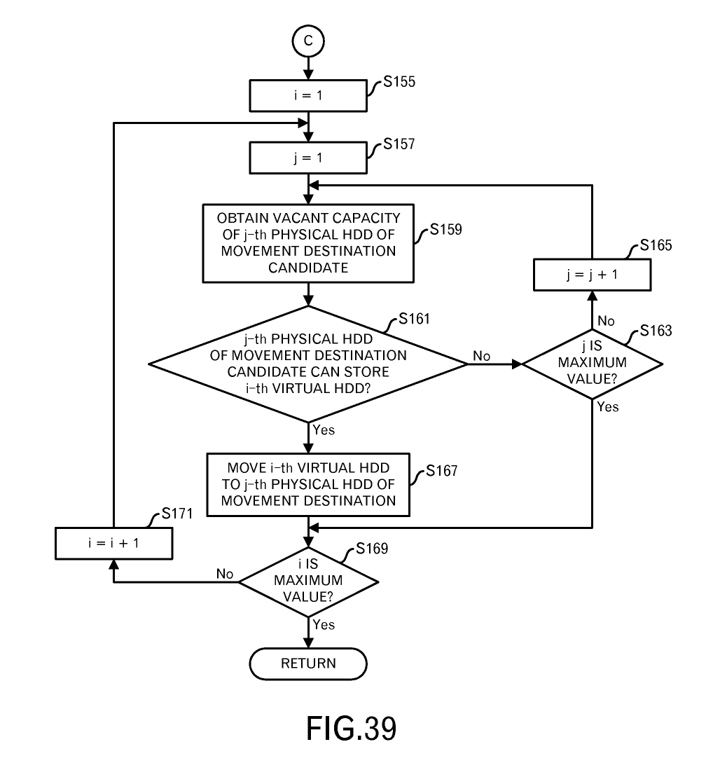

Then, the controller 5031 sorts the physical HDDs of the movement destination candidate in descending order of the point (step S153). In an example of FIG. 38, the order “P3, P1 then P2” is obtained. The processing shifts to a processing in FIG. 39 through terminal C.

Shifting to the explanation of the processing in FIG. 39, the controller 5031 initializes a counter i to “1” (step S155). Moreover, the controller 5031 initializes a counter j to “1” (step S157). Then, the controller 5031 obtains a vacant capacity of the j-th physical HDD of the movement destination candidate from the data storage unit 5036 (step S159). In response to an instruction of the controller 5031, the physical HDD data collector 5034 may obtain the vacant capacity at this time. Moreover, the controller 5031 obtains the size of the i-th virtual HDD, and determines whether or not the i-th virtual HDD can be stored in the j-th physical HDD of the movement destination candidate (step S161). If the i-th virtual HDD cannot be stored, the controller 5031 determines whether or not j is the maximum value of j (step S163). When j is not the maximum value of j, the controller 5031 increments j by “1” (step S165), and the processing returns to the step S159. On the other hand, when j is the maximum value of j, the processing shifts to step S169.

On the other hand, when it is determined that the i-th virtual HDD can be stored in the j-th physical HDD of the movement destination candidate, the controller 5031 instructs the movement processing unit 5039 to move the i-th virtual HDD to the j-th physical HDD of the movement destination, and the movement processing unit 5039 performs a movement processing of the virtual HDD in response to this instruction (step S167). Then, the processing shifts to the step S169.

Then, the controller 5031 determines whether or not i is the maximum value of i (step S169). When i is not the maximum value of i, the controller 5031 increments i by “1” (step S171), and the processing shifts to the step S157. On the other hand, when i becomes the maximum value of i, the processing returns to the calling-source processing.

By performing the aforementioned processing, it becomes possible to move the virtual HDDs to the physical HDD that is determined at that time to be appropriate, based on indicator values that vary dynamically such as the performance and loads of the physical HDDs.

Moreover, the migration of the virtual HDD is automatically performed by the weights set according to the administrator or the like.

### Embodiment 6

In this embodiment, a processing when the movement of the virtual HDD is performed based on the future prediction of the load instead of the failure sign of the physical HDD will be explained.

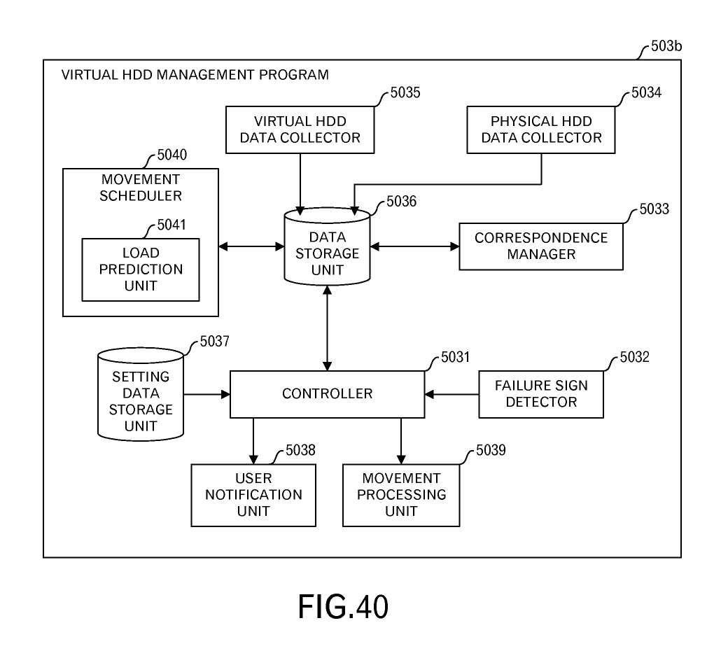

When a virtual HDD management program 503b in this embodiment is executed, functions illustrated in FIG. 40 are realized. In addition to the functions of the virtual HDD management program 503 illustrated in FIG. 3, a movement scheduler 5040 is added. The movement scheduler 5040 includes a load prediction unit 5041.

In this embodiment, the load prediction unit 5041 of the movement scheduler 5040 performs future load prediction from data of the load of each physical HDD, which is collected by the physical HDD data collector 5034 (i.e. an I/O request amount), and data of the load of each virtual HDD, which is collected by the virtual HDD data collector 5035 (i.e. an I/O request amount). A time span of the load prediction is arbitrary, however, the load prediction for one day, for example, is performed. Then, whether or not the movement of each virtual HDD is appropriate is determined based on whether or not a period that the predicted load exceeds a threshold that is preset, for example, appears. Then, when the movement of the virtual HDD should be performed, a time for the movement of the virtual HDD is calculated to identify a timing at which the movement is started, and the controller 5031 causes the movement processing unit 5039 to perform the movement at that timing.

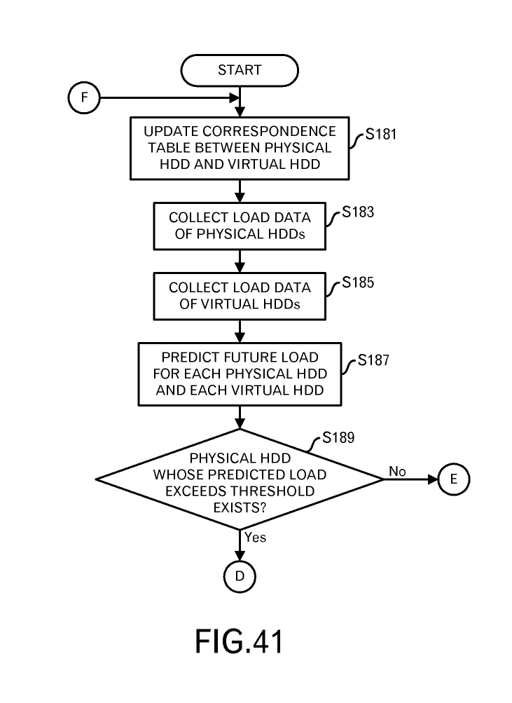

Next, a processing relating to this embodiment will be explained by using FIGS. 41 to 46.

Firstly, the correspondence manager 5033 monitors the physical HDDs and virtual HDDs in the system, and updates the state of the collation data (the association table) (here, the correspondence table) between the physical HDD and the virtual HDD with the latest state, for example (FIG. 41: step S181). The correspondence table is stored in the data storage unit 5036, and is data as illustrated in FIG. 6, for example.

Furthermore, the physical HDD data collector 5034 collects the load data (e.g. data of the I/O request amount) from the OS or the like in each physical machine in the system, for example, and stores the collected data in the data storage unit 5036 (step S183). Moreover, the virtual HDD data collector 5035 obtains the load data (e.g. data of the I/O request amount) from the management software 3053 for the virtual machine operation, and stores the obtained data in the data storage unit 5036 (step S185). Data as illustrated in FIG. 16, for example, is stored in the data storage unit 5036.

Then, the load prediction unit 5041 of the movement scheduler 5040 performs a processing to predict a future load of each physical HDD and each virtual HDD based on the load data stored in the data storage unit 5036 (step S187). An algorithm for predicting the future load is not a main portion of this embodiment, and various conventional techniques exist. Therefore, any of the techniques is employed. Simply, an average curve for several past days may be generated.

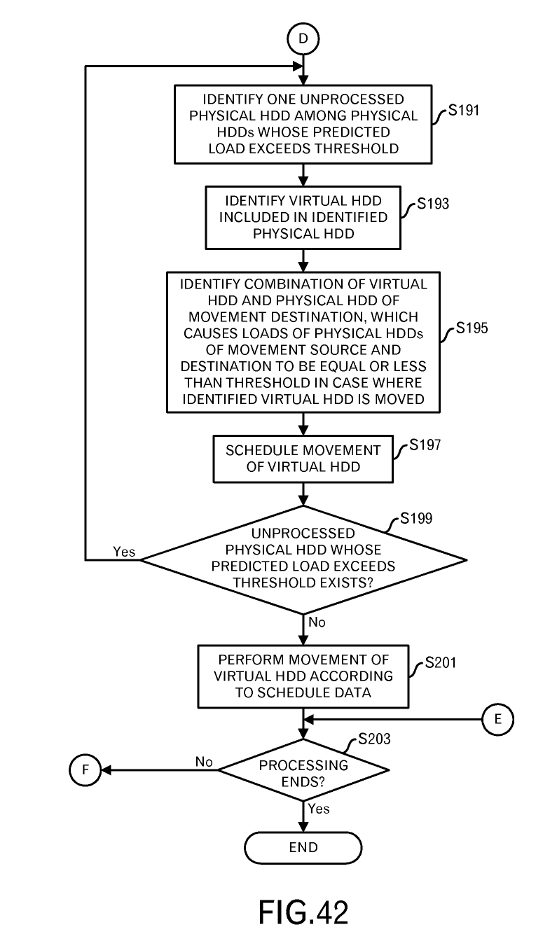

Then, the movement scheduler 5040 determines whether or not a physical HDD whose future load exceeds the threshold exists (step S189). When no physical HDD whose future load exceeds the threshold exists, the processing shifts to step S203 in FIG. 42 by way of terminal E. On the other hand, when a period in which the future load for any physical HDD exceeds the threshold appears, the processing shifts to step S191 in FIG. 42 by way of terminal D.

Shifting to the explanation of the processing subsequent to the terminal D, the movement scheduler 5040 identifies one unprocessed physical HDD among physical HDDs whose future load exceeds the threshold (step S191). The movement scheduler 5040 identifies, from the correspondence table, virtual HDDs included in the identified physical HDD (step S193).

Then, when the virtual HDD identified at the step S193 is moved, the movement scheduler 5040 identifies a combination of the virtual HDD and the physical HDD of the movement destination, which realizes that the loads of the physical HDDs of the movement source and the movement destination are equal to or less than the threshold (step S195).

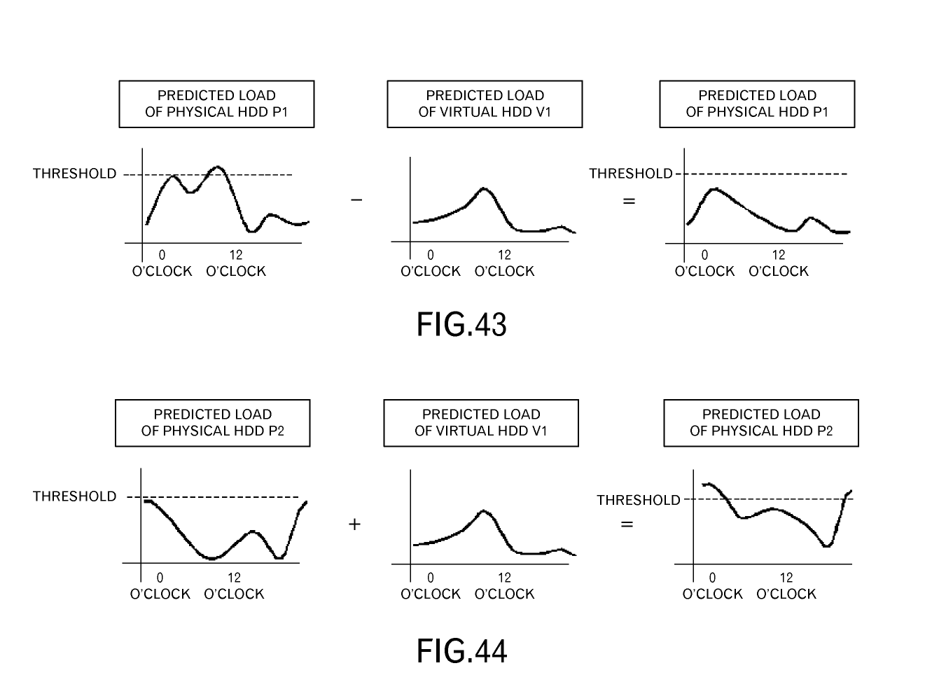

For example, as illustrated in the left side of FIG. 43, it is assumed that the future load that exceeds the threshold is predicted from 10 o'clock to 12 o'clock for the physical HDD “P1”. Moreover, as illustrated in the central of FIG. 43, in case where the predicted load for the virtual HDD “V1” stored in the physical HDD “P1” is high from 10 o'clock to 12 o'clock, when the virtual HDD “V1” is moved, the predicted load for the physical HDD “P1” is less than the threshold for all time periods as illustrated in the right side of FIG. 43. On the other hand, as illustrated in the left side of FIG. 44, when the future load of the physical HDD “P2” is predicted and the virtual HDD “V1” is moved to the physical HDD “P2”, a state that the predicted load for the physical HDD “P2” partially exceeds the threshold for time bands (22 o clock to 4 o'clock) as illustrated in the right side of FIG. 44.

By moving, from a physical HDD of the movement source, in which a time period exists that the load exceeds the threshold, any of the virtual HDDs stored in the physical HDD of the movement source is moved to any physical HDD of the movement destination, a search is performed for the combination of the virtual HDD and the physical HDD of the movement destination, which realizes that the loads of the physical HDDs of the movement source and the movement destination become less than the threshold, among all combinations.

As illustrated in FIG. 44, there is a case where the overload state of the physical HDD “P2” from 22 o'clock to 4 o'clock cannot be resolved instead of the overload state of the physical HDD “P1” from 10 o'clock to 12 o'clock, which was intended to initially resolve. In such a case, when the virtual HDD “V1” is returned to the physical HDD “P1” of the movement source before 22 o'clock, it is possible to also resolve the overload state for the physical HDD “P2”. Thus, when the time bands of the overload state are different and the overload state cannot be avoided by moving the virtual HDD again, the movement and return may be employed.

Moreover, when plural physical HDDs whose predicted load exceeds the threshold exist, one physical HDD is influenced by the movement of the virtual HDDs for other physical HDDs. Therefore, the movement of a virtual HDD in a physical HDD to be processed is determined based on the state that the movement of virtual HDDs for other physical HDDs has been performed. For example, the overload state is avoided by other combinations of the physical HDDs of the movement source and the movement destination to the greatest extent practicable.

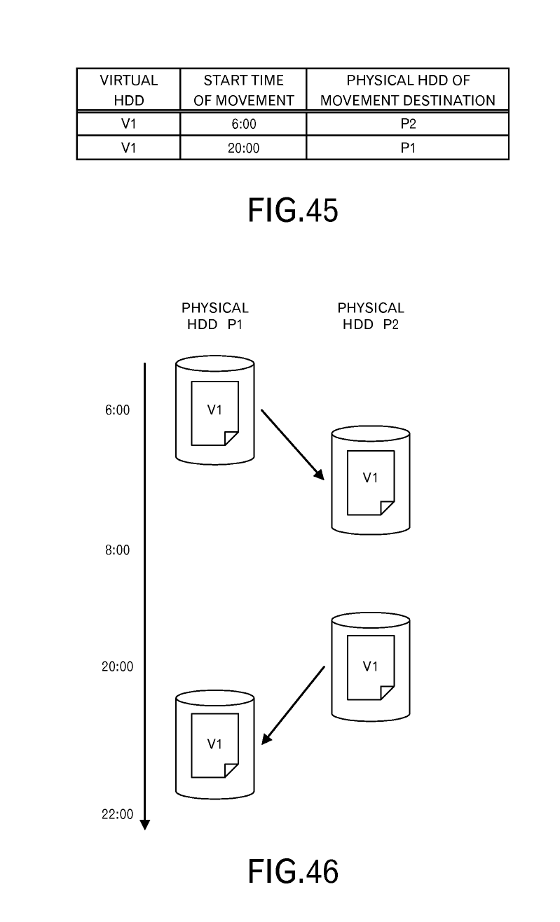

After that, the movement scheduler 5040 calculates a time for the movement based on the size of the virtual HDD and the transfer speed, calculates a movement start time by [(a time at which the overload state starts)−(the calculated time)−margin], and stores correlation data of an identifier of the virtual HDD, the movement start time and an identifier of the physical HDD of the movement destination in the data storage unit 5036 (step S197). For example, in the aforementioned example, data as illustrated in FIG. 45 is stored. In other words, the identifier of the virtual HDD, the movement start time and the identifier of the physical HDD of the movement destination are correlated and stored.

Then, the movement scheduler 5040 determines whether or not there is an unprocessed physical HDD whose predicted load exceeds the threshold (step S199). When there is an unprocessed physical HDD whose predicted load exceeds the threshold, the processing returns to the step S191. On the other hand, when there is no unprocessed physical HDD whose predicted load exceeds the threshold, the controller 5031 monitors schedule data stored in the data storage unit 5036, and when the present time is the movement start time included in the schedule data, the controller 5031 instructs the movement processing unit 5039 to move the virtual HDD included in the schedule data to the physical HDD of the movement destination, and the movement processing unit 5039 moves the virtual HDD according to the instruction (step S201).

For example, in case of the schedule data illustrated in FIG. 45, a movement processing in FIG. 46 is performed. In other words, at 6:00, the virtual HDD “V1” is moved from the physical HDD “P1” to the physical HDD “P2”, and the movement is caused to be completed until 8:00 when it is assumed that the overload state begins. Moreover, at 20:00, the virtual HDD “V1” is moved from the physical HDD “P2” to the physical HDD “P1”, and the movement is caused to be completed until 22:00 when it is assumed that the overload state begins.

Such a processing is repeated until the processing ends (step S203). In other words, when the processing does not end, the processing returns to the step S181 in FIG. 41 through terminal F.

By performing the aforementioned processing, it becomes possible to enhance the throughput of the system. Moreover, because the number of physical HDDs does not increase, it is profitable on the cost side.

Although the embodiments of this technique were explained, this technique is not limited to those.

For example, as long as no contradiction occurs, the embodiments may be combined. Moreover, in the embodiment in which the processing is performed based on plural parameters, a processing may be performed by using only some parameters among the plural parameters.

Furthermore, the aforementioned functional block diagram is a mere example, and does not always correspond to an actual program module configuration. As for the processing flows, as long as the processing result does not change, plural steps may be executed in parallel, and the execution turns of them may be exchanged.

Moreover, the aforementioned functions may be implemented by plural computers.

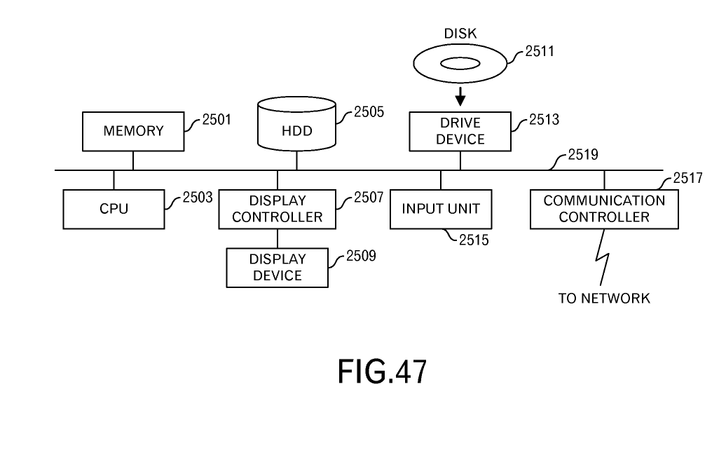

Furthermore, the aforementioned various servers may have a configuration as illustrated in FIG. 47. In such a case, each server have, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 47. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

An information processing method relating to a first aspect of the embodiments includes: (A) detecting a failure sign of a first physical disk in a system having plural physical disks, each of which stores one or plural virtual disks included in a virtual machine that is executed on a physical machine; (B) identifying one or plural certain virtual disks stored in the first physical disk from association data that associates a virtual disk with a physical disk that stores the virtual disk; (C) moving at least one of the identified one or plural certain virtual disks to a second physical disk that is a physical disk other than the first physical disk and has a capability to store a virtual disk to be moved to the second physical disk, based on a dynamic or static characteristic of the one or plural certain virtual disks or a dynamic or static characteristic of a physical disk other than the first physical disk; and (D) updating the association data according to the moving.

Thus, it becomes possible to automatically perform migration of the virtual disk included in the virtual machine that is executed on a physical machine included in the system. In other words, it becomes possible to suppress the maintenance costs.

The information processing method relating to the first aspect of the embodiments may further include: (E) after a third physical disk is installed in the system on behalf of the first physical disk, determining whether at least a virtual disk that was moved in the moving should be moved; and (F) second moving a virtual disk that is determined to be moved to either of physical disks in the system. It becomes possible to appropriately perform reallocation of the virtual disks according to the installation of the third physical disk.

Moreover, in the moving, the identified one or plural virtual disks may be moved according to a predetermined priority order of the plural virtual disks. For example, in case where the priority for the continuous operation, the virtual disk prioritized for the continuous operation is early moved.

Moreover, in the moving, the second physical disk may be determined according to a predetermined priority order of the plural physical disks. This means that settings by the administrator or the like are followed.

Furthermore, in the moving and the second moving, the second or third physical disk may be selected according to an estimated residual life time. When the estimated residual life time is long, the virtual disk can be stored continuously and stably.

The information processing method relating to the first aspect of the embodiment may further include: collecting at least either of a load indicator value and a performance indicator value that change with respect to time for each of the plural physical disks included in the system. In such a case, in the aforementioned moving, the second physical disk may be selected based on the at least either of the load indicator value and the performance indicator value. Thus, an appropriate physical disk is selected according to the present load or performance.

Furthermore, in the aforementioned moving, the second or third physical disk may be selected based on an indicator value obtained by weighting the collected load indicator value and performance indicator value or adding them with weights. For example, it becomes possible to cope with a case where an important indicator is different based on the instruction of a user or administrator.

Moreover, in the aforementioned moving, turns of the identified one or plural certain virtual disks may be determined based on importance degrees and priority degrees, which are preset for the plural virtual disks. For example, the importance degree for the virtual disk including an important business data may be heightened, and such a virtual disk may be early moved.

Furthermore, the information processing method relating to the first aspect of the embodiments may further include: collecting a load indicator value that changes with respect to time for each of the plural virtual disks included in the system. In such a case, in the aforementioned moving, turns of the identified one or plural certain virtual disks may be determined based on the collected load indicator value of each of the plural virtual disks. Because the load of the virtual disk is low or high, the turns of the movement are determined according to the current load status.

Furthermore, in the aforementioned moving, turns of the identified one or plural certain virtual disks may be determined further based on either of an availability priority and a performance priority that are preset for each of the plural virtual disks. The turns of the movement are determined according to various aspects.

Furthermore, the turns of the identified one or plural certain virtual disks may be determined based on an indicator value obtained by weighting the load indicator value, the availability priority and the performance priority, or adding them with weights. The evaluation is performed based on decision for the importance by the user or administrator.

Furthermore, in the aforementioned moving, the second physical disk may be determined further based on at least either of an availability indicator value and a reliability indicator value that are preset for each of the plural physical disks. The physical disk of the movement destination is also determined according to the evaluation in various aspects.

Moreover, the information processing method relating to the first aspect of the embodiment may further include: collecting a load indicator value that changes with respect to time for each of the plural virtual disks included in the system. In such a case, in the aforementioned moving, after one virtual disk is moved, a physical disk to which a next virtual disk is to be moved is determined based on a result obtained by adding a load indicator value of the one virtual disk to a load indicator value of a physical disk to which the one virtual disk was moved. When plural virtual disks are moved, the movement destination of the virtual disk to be moved next is determined after taking into consideration the influence of the virtual disk that has been moved.

Moreover, the information processing method relating to the first aspect of the embodiments may further include: after a third physical disk is installed in the system on behalf of the first physical disk, returning a virtual disk moved in the moving to the third physical disk. This is because the original state is recovered.

Furthermore, the information processing method relating to the first aspect of the embodiments may further include: collecting an access frequency that changes with respect to time for each of the plural virtual disks included in the system. In such a case, whether at least a virtual disk that was moved in the moving should be moved may be determined based on the access frequency and a performance indicator value of each of the plural physical disks included in the system. This is because there is a case where it is preferable not to move the virtual disk in view of the throughput in the system or the like.

An information processing method relating to a second aspect of the embodiments includes: (A) collecting a load indicator value for each physical disk and each virtual disk in a system having plural physical disks, each of which stores one or plural virtual disks included in a virtual machine that is executed on a physical machine; (B) identifying a physical disk for which it is presumed that a period exists in which a load indicator value that is predicted for the physical disk based on the collected load value exceeds a threshold; (C) identifying one or plural certain virtual disks stored in the identified physical disk; (D) identifying a physical disk of a movement destination for at least one of the identified one or plural certain virtual disks from the collected load indicator value so that a load indicator value of the identified physical disk after movement and a load indicator value of the physical disk of the movement destination after the movement are less than the threshold in the period; and (E) performing scheduling to move the at least one of the identified one or plural certain virtual disks to the identified physical disk of the movement destination before the period.

Thus, it is possible to enhance the throughput of the system without installing any new physical disk.

Moreover, the information processing method relating to the second aspect of the embodiment may further include: (F) upon detecting that a load indicator value of the identified physical disk of the movement destination after the movement exceeds the threshold in a second period other than the period, identifying a second physical disk of a movement destination for at least one of virtual disks stored in the identified physical disk of the movement destination so that a load indicator value of the identified physical disk of the movement destination after second movement and a load indicator value of the second physical disk of the movement destination after the second movement are less than the threshold in the second period; and (G) performing scheduling to move the at least one of virtual disks stored in the identified physical disk of the movement destination to the identified second physical disk of the movement destination before the second period.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a program for causing a computer to execute a process, the process comprising:
detecting a failure sign of a first physical disk in a system having a plurality of physical disks, wherein each of the plurality of physical disks stores one or a plurality of virtual disks included in a virtual machine that is executed on a physical machine;
identifying one or plural virtual disks stored in the first physical disk from association data that associates a virtual disk with a physical disk that stores the virtual disk; and
moving at least one of the identified one or plural virtual disks to a second physical disk that is a physical disk other than the first physical disk and has a capability to store a virtual disk to be moved to the second physical disk, based on a dynamic or static characteristic of the one or plural virtual disks or a dynamic or static characteristic of a physical disk other than the first physical disk.

2. The non-transitory computer-readable storage medium as set forth in claim 1, wherein the process comprises:
after a third physical disk is installed in the system on behalf of the first physical disk, determining whether at least a virtual disk that was moved in the moving should be moved; and
second moving a virtual disk that is determined to be moved to either of physical disks in the system.

3. The non-transitory computer-readable storage medium as set forth in claim 1, wherein, in the moving, the identified one or plural virtual disks are moved according to a predetermined priority order of the plurality of virtual disks.

4. The non-transitory computer-readable storage medium as set forth in claim 1, wherein, in the moving, the second physical disk is determined according to a predetermined priority order of the plurality of physical disks.

5. The non-transitory computer-readable storage medium as set forth in claim 1, wherein the second physical disk is selected according to an estimated residual life time.

6. The non-transitory computer-readable storage medium as set forth in claim 1, wherein the process further comprises:
collecting at least either of a load indicator value and a performance indicator value that change with respect to time for each of the plurality of physical disks included in the system, and
wherein, in the moving, the second physical disk is selected based on the at least either of the load indicator value and the performance indicator value.

7. The non-transitory computer-readable storage medium as set forth in claim 6, wherein, in the moving, the second physical disk is selected based on an indicator value obtained by weighting the collected load indicator value and performance indicator value.

8. The non-transitory computer-readable storage medium as set forth in claim 1, wherein, in the moving, turns of the identified one or plural virtual disks are determined based on importance degrees and priority degrees, which are preset for the plurality of virtual disks.

9. The non-transitory computer-readable storage medium as set forth in claim 1, wherein the process further comprises:
collecting a load indicator value that changes with respect to time for each of the plurality of virtual disks included in the system,
wherein, in the moving, turns of the identified one or plural virtual disks are determined based on the collected load indicator value of each of the plurality of virtual disks.

10. The non-transitory computer-readable storage medium as set forth in claim 9, wherein, in the moving, turns of the identified one or plural virtual disks are determined further based on either of an availability priority and a performance priority that are preset for each of the plurality of virtual disks.

11. The non-transitory computer-readable storage medium as set forth in claim 10, wherein the turns of the identified one or plural virtual disks are determined based on an indicator value obtained by weighting the load indicator value, the availability priority and the performance priority.

12. The non-transitory computer-readable storage medium as set forth in claim 6, wherein, in the moving, the second physical disk is determined further based on at least either of an availability indicator value and a reliability indicator value that are preset for each of the plurality of physical disks.

13. The non-transitory computer-readable storage medium as set forth in claim 6, wherein the process further comprises:
collecting a load indicator value that changes with respect to time for each of the plurality of virtual disks included in the system,
wherein, in the moving, after one virtual disk is moved, a physical disk to which a next virtual disk is to be moved is determined based on a result obtained by adding a load indicator value of the one virtual disk to a load indicator value of a physical disk to which the one virtual disk was moved.

14. The non-transitory computer-readable storage medium as set forth in claim 1, wherein the process further comprises:
after a third physical disk is installed in the system on behalf of the first physical disk, returning a virtual disk moved in the moving to the third physical disk.

15. The non-transitory computer-readable storage medium as set forth in claim 2, wherein the process further comprises:
collecting an access frequency that changes with respect to time for each of the plurality of virtual disks included in the system,
wherein whether at least a virtual disk that was moved in the moving should be moved is determined based on the access frequency and a performance indicator value of each of the plurality of physical disks included in the system.

16. A non-transitory computer-readable storage medium storing a program for causing a computer to execute a process, the process comprising:
collecting a load indicator value for each physical disk and each virtual disk in a system having a plurality of physical disks, wherein each of the plurality of physical disks stores one or a plurality of virtual disks included in a virtual machine that is executed on a physical machine;
identifying a physical disk for which it is presumed that a period exists in which a load indicator value that is predicted for the physical disk based on the collected load value exceeds a threshold;
identifying one or plural virtual disks stored in the identified physical disk;
identifying a physical disk of a movement destination for at least one of the identified one or plural virtual disks from the collected load indicator value so that a load indicator value of the identified physical disk after movement and a load indicator value of the physical disk of the movement destination after the movement are less than the threshold in the period; and
performing scheduling to move the at least one of the identified one or plural virtual disks to the identified physical disk of the movement destination before the period.

17. The non-transitory computer-readable storage medium as set forth in claim 16, wherein the process further comprising:
upon detecting that a load indicator value of the identified physical disk of the movement destination after the movement exceeds the threshold in a second period other than the period, identifying a second physical disk of a movement destination for at least one of virtual disks stored in the identified physical disk of the movement destination so that a load indicator value of the identified physical disk of the movement destination after second movement and a load indicator value of the second physical disk of the movement destination after the second movement are less than the threshold in the second period; and
performing scheduling to move the at least one of virtual disks stored in the identified physical disk of the movement destination to the identified second physical disk of the movement destination before the second period.

18. An information processing method, comprising:
detecting, by using a computer, a failure sign of a first physical disk in a system having a plurality of physical disks, wherein each of the plurality of physical disks stores one or a plurality of virtual disks included in a virtual machine that is executed on a physical machine;
identifying, by using the computer, one or plural virtual disks stored in the first physical disk from association data that associates a virtual disk with a physical disk that stores the virtual disk; and
moving, by using the computer, at least one of the identified one or plural virtual disks to a second physical disk that is a physical disk other than the first physical disk and has a capability to store a virtual disk to be moved to the second physical disk, based on a dynamic or static characteristic of the one or plural virtual disks or a dynamic or static characteristic of a physical disk other than the first physical disk.

19. An information processing method, comprising:
collecting, by using a computer, a load indicator value for each physical disk and each virtual disk in a system having a plurality of physical disks, wherein each of the plurality of physical disks stores one or a plurality of virtual disks included in a virtual machine that is executed on a physical machine;
identifying, by using the computer, a physical disk for which it is presumed that a period exists in which a load indicator value that is predicted for the physical disk based on the collected load value exceeds a threshold;
identifying, by using the computer, one or plural virtual disks stored in the identified physical disk;
identifying, by using the computer, a physical disk of a movement destination for at least one of the identified one or plural virtual disks from the collected load indicator value so that a load indicator value of the identified physical disk after movement and a load indicator value of the physical disk of the movement destination after the movement are less than the threshold in the period; and
performing, by using the computer, scheduling to move the at least one of the identified one or plural virtual disks to the identified physical disk of the movement destination before the period.

20. An information processing apparatus, comprising:
a memory; and
a processor configured to execute a process, the process comprising:
detecting a failure sign of a first physical disk in a system having a plurality of physical disks, wherein each of the plurality of physical disks stores one or a plurality of virtual disks included in a virtual machine that is executed on a physical machine;
identifying one or plural virtual disks stored in the first physical disk from association data that associates a virtual disk with a physical disk that stores the virtual disk; and
moving at least one of the identified one or plural virtual disks to a second physical disk that is a physical disk other than the first physical disk and has a capability to store a virtual disk to be moved to the second physical disk, based on a dynamic or static characteristic of the one or plural virtual disks or a dynamic or static characteristic of a physical disk other than the first physical disk.

21. An information processing apparatus, comprising:
a memory; and
a processor configured to execute a process, the process comprising:
collecting a load indicator value for each physical disk and each virtual disk in a system having a plurality of physical disks, wherein each of the plurality of physical disks stores one or a plurality of virtual disks included in a virtual machine that is executed on a physical machine;
identifying a physical disk for which it is presumed that a period exists in which a load indicator value that is predicted for the physical disk based on the collected load value exceeds a threshold;
identifying one or plural virtual disks stored in the identified physical disk;
identifying a physical disk of a movement destination for at least one of the identified one or plural virtual disks from the collected load indicator value so that a load indicator value of the identified physical disk after movement and a load indicator value of the physical disk of the movement destination after the movement are less than the threshold in the period; and
performing scheduling to move the at least one of the identified one or plural virtual disks to the identified physical disk of the movement destination before the period.
